(19) United States
(12) Patent Application Publication
(10) Pub. No.: US 2026/0179095 A1
(43) Pub. Date: Jun. 25, 2026

(54) REAL-TIME CLASSIFICATION FOR PERSONALIZED INTERACTIONS

(71) Applicant: Block, Inc., Oakland, CA (US)

(72) Inventors: Andrew Paul Techmeier, San Francisco, CA (US); Suraj Jayakumar, South San Francisco, CA (US)

(73) Assignee: Block, Inc., Oakland, CA (US)

(21) Appl. No.: 18/990,895

(22) Filed: Dec. 20, 2024

(51) Int. Cl. G06Q 20/40; G06F 11/34; G06F 40/284; G06Q 20/22

(52) U.S. Cl. CPC G06Q 20/4016; G06F 11/3438; G06F 40/284; G06Q 20/223

(57) ABSTRACT

Technologies are described herein for classifying personalized interactions at an application. A method can include receiving and storing user inputs associated with interactions between users of the application, building historical models based on the user inputs to classify the interactions, wherein building a historical model for a particular user comprises aggregating particular user inputs associated with a set of previous interactions between a particular user and other users, in association with a pending interaction for the particular user and during the pending transaction associating a current user input with the historical model for the particular user and based on analyzing the historical model for the particular user, determining that the pending interaction satisfies a condition, and interrupting the pending interaction based on determining that the pending interaction satisfies the condition.

### TECHNICAL FIELD

Applications, which are downloadable and executable on user devices, enable users to interact with other users. Such applications are provided by a service provider and utilize one or more network connections to transmit data among and between user devices to facilitate such interactions. Such interactions can be associated with data that provides context associated with such interactions.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram showing aspects of an illustrative operating environment and several logical components provided by the technologies described herein;

FIG. 2A is a schematic of an example user interface depicting a personalized interaction, according to an implementation presented herein;

FIG. 2B is a schematic of an example user interface depicting an interrupted personalized interaction, according to an implementation presented herein;

FIG. 2C is a schematic of an example user interface depicting a cancelled personalized interaction, according to an implementation presented herein;

FIG. 2D is a schematic of an example user interface depicting a completed personalized interaction, according to an implementation presented herein;

FIG. 2E illustrates historical personalized interaction data, according to an implementation presented herein;

FIG. 2F illustrates an aggregate of the historical personalized interaction data of FIG. 2E, according to an implementation presented herein;

FIG. 3 is a flowchart showing aspects of a method of classification of personalized interactions based on a fraud condition, according to an implementation presented herein;

FIG. 4 is a flowchart showing aspects of a method of classification of personalized interactions based on a fraud pattern, according to an implementation presented herein;

FIG. 5 is a diagram showing aspects of a method of classification of personalized interactions, according to an implementation presented herein;

FIG. 6 is a flowchart of a method of training of a language model and a classification model, according to an implementation presented herein;

FIG. 7 illustrates an example environment that may employ the techniques presented herein to effectuate classification of personalized interactions, according to an implementation presented herein;

FIG. 8 illustrates an example environment that may employ the techniques presented herein to effectuate classification of personalized interactions, according to an implementation presented herein; and

FIG. 9 illustrates an example environment that may employ the techniques presented herein to effectuate classification of personalized interactions, according to an implementation presented herein.

### DETAILED DESCRIPTION

The following detailed description is directed to technologies for classification of personalized interactions, such as personalized interactions between users of a service provider network. Personalized interactions may include peer-to-peer (P2P) interactions and other interactions such as payments, fund transfers, cryptocurrency transfers, stock transfers, and others. Personalized interactions may also include interactions between two users where personalized content is associated with the interaction.

For example, many services may allow for a sender or recipient to associate personalized content (e.g., a message, description, design, sound, combination of the foregoing, or the like) that is associated with one or more interactions. The personalized content may include any suitable message, description, and/or design including text, emojis, stickers, backgrounds, images, videos, sound (e.g., music, speech, etc.), combinations of the forgoing, and others. Some personalized messages may be in reference to goods or services being exchanged between two users, for example. Some personalized messages may describe a portion of the interaction (e.g., “Happy Birthday!”) or may describe a good (e.g., food, sweets, shoes, etc.), a service (e.g., lawn service, grass cutting, haircut, dog sitting, etc.), or another aspect of the interaction.

Conventional interaction systems may process individual interactions as they are received. For example, conventional interaction systems may receive a request for an interaction, classify the interaction based on the information or data contained therein and/or based on multiple real-time data signals, and process the interaction (or not) based on the classification, for instance, to determine whether the interaction is likely to be fraudulent (or not), compliant (or not) with terms of service or other policies, or the like. For example, many conventional systems rely on interpreting a single transaction to determine whether a policy or other violation exists. As a result, some users may circumvent detection through use of coded messages or other circumvention techniques. For example, a user attempting to transmit funds to pay for an illegal good may describe the interaction differently, may represent the illegal good in euphemisms, emojis, images, or may otherwise attempt to circumvent detection. Furthermore, a user may rarely attempt to implement a personalized interaction that violates policy or terms, such that conventional detection may be thwarted based on the rarity of the interaction. Moreover, a user may request many different personalized interactions, with a sub-portion violating policy or terms, while other interactions may be compliant. As such, due to the difficulty of detecting transactions that are fraudulent, non-compliant, or the like due to the limited information available to conventional interaction systems, such conventional interaction systems may require increased computational resources to achieve a result, increased bandwidth to account for multiple real-time signals, increased storage resources, and others.

However, as described herein, example implementations may provide systems, methods, and apparatuses configured to provide automated classification of personalized interactions that overcome these and other drawbacks. The example implementations may perform a form of real-time blocking (RTB) that reduces computing resources and network bandwidth associated with detection of policy violating or term violating personalized interactions.

For example, some implementations may relate to aggregating data associated with prior user interactions (e.g., user input, payment notes, transaction memos, emojis, text, images, and others) to ascertain patterns of behavior that indicate policy-violating activities such as fraud and/or illegal activity. The patterns of behavior may be used to build a historical model for a particular user or users. In an example, a particular user's historical model may be stored at a data store and may be augmented or altered as new interactions occur. That is, the historical model can leverage context associated with multiple interactions over time to improve the accuracy and precision of detection. The historical model may be used to determine a classification for a pending interaction. Appropriate actions for the pending interaction may be taken based on the determined classification.

In some implementations, prior user interactions may be aggregated and stored as historical interaction data. The historical interaction data may be used to train a language model and a classification model. For example, the historical interaction data may be received and stored at a service provider network for training. After training, the models may be deployed at the service provider network for real-time classification of personalized interactions.

As a new interaction request is received, a historical model for the initiating user may be built from a subset of the historical interaction data. In some implementations, the historical model may be built in real-time or substantially real-time in response to the new interaction request. In some implementations, the historical model may be built prior to classification of an interaction and in response to the new interaction request. In some implementations, the historical model may be built during or in response to a first or initial interaction, and may be adjusted for subsequent interaction requests (i.e., augmented, expanded, and/or otherwise modified).

As an example of building a historical model (e.g., in real-time, in response to a request, augmenting an existing model, and others), a sliding window of time (5 days, 30 days, 90 days, etc.) and/or a subset of available interactions (e.g., 10 interactions, 50 interactions, 100 interactions, etc.) may be input to a tokenization component. The tokenization component may also input the new interaction request (or data contained therein) to create a set of tokenized features to be input to the trained language model. In some implementations, the tokenization component may tokenize features based on the sliding window of time, subset of available interactions, and/or the new interaction request. For example, the tokenization component may be configured to tokenize text, emojis, images, and other data that is part of the personalized interaction, and output the set of tokenized features.

The trained language model may take as input the set of tokenized features and may output a sequence of embeddings. The sequence of embeddings may represent the historical model as well as the new interaction as a single string of embeddings. The trained language model may output the sequence of embeddings to the trained classification model. The trained classification model may take as input, the sequence of embeddings and output a classification for the pending personalized interaction. The classification may be a numerical value representing a likelihood that a pending personalized interaction is policy-violating or not policy-violating.

In some implementations, if the pending personalized interaction meets or exceeds a threshold for classification, the personalized interaction may be interrupted. For example, if the pending personalized interaction is determined to be related to a “super user” or “ambassador” (e.g., users who have historically implemented altruistic interactions), the personalized interaction may be interrupted to display a user status or present additional personalization options. For example, if the pending personalized interaction is determined to be policy-violating, the personalized interaction may be interrupted prior to processing or transmission to a recipient. For example, if the pending personalized interaction is determined to be related to illegal goods or services, the personalized interaction may be interrupted prior to processing or transmission to a recipient. For example, if the pending personalized interaction is likely fraudulent or associated with a fraudulent account based on the classification, the transaction may be interrupted prior to dispersing funds. And additionally, in all of these examples, additional actions may be taken, including escalation for account review, escalation for compliance review, escalation for reporting to an authority, and/or other actions.

As described herein, various automated computing techniques leverage personalized interaction history to classify individual interactions, for example, to identify altruistic users, to ascertain violation of policy or terms, to identify fraud, and/or to identify compliance issues. These and other aspects allow for accurate violation detection with less-intensive computing and less network resources (e.g., using a set of prior transactions in a historical model to identify patterns, as opposed to relying on multiple real-time inputs and/or a single transaction memo to ascertain a violation). For example, relying on a particular user's historical model rather than multiple real-time inputs utilizes less network bandwidth as compared to a model relying on real-time signals transmitted over a network. Additionally, relying on a particular user's historical model utilizes less computing resources than a large, complex model processing a transaction or interaction based on a single transaction memo and multiple real-time inputs. Additionally, through use of a feature data store, less querying from internal data sources of a service provider network are necessary, thereby further reducing computing resource usage.

In some examples, by detecting and preventing the execution of policy-violating interactions, the service provider can proactively reduce the unnecessary processing corresponding to fraudulent or policy-violating interactions, as well as deter future violating behavior. As the volume of fraudulent interactions increases, a service provider's ability to process legitimate interactions for other users may be reduced. The service provider may also detect potential fraudulent transactions (e.g., such as fraudulent payments or other interactions) and interrupt or redirect the transactions to avoid the fraudulent transactions from slowing down the processing system. This reduces further unnecessary and wasteful transaction processing related to reversing fraudulent transactions.

Accordingly, the techniques described herein are scalable such that classification of a plurality of different interactions may be classified in substantially real-time, while reducing computing resources and network bandwidth associated with conventionally large, specialized models that rely on multiple real-time input signals.

As described herein, these and other technical effects and benefits overcome drawbacks associated with conventional classification technologies, and will become apparent in this disclosure.

In the following detailed description, references are made to the accompanying drawings that form a part hereof, and which are shown by way of illustration as specific implementations or examples. Referring now to the drawings, aspects of computing systems and methodologies for automated event stream prioritization and resource management are described in detail.

It should be appreciated that the subject matter presented herein may be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures, and other types of structures that perform particular tasks or implement particular abstract data types.

Those skilled in the art will also appreciate that aspects of the subject matter described herein may be practiced on or in conjunction with other computer system configurations beyond those described herein, including multiprocessor systems, microprocessor-based or programmable consumer electronics, minicomputers, mainframe computers, handheld computers, personal digital assistants, e-readers, mobile telephone devices, tablet computing devices, special-purposed hardware devices, network appliances, and the like. The configurations described herein may be practiced in distributed computing environments, where tasks may be performed by remote computing devices that are linked through a communications network. In a distributed computing environment, program modules may be located in both local and remote memory storage devices.

In the following detailed description, references are made to the accompanying drawings that form a part hereof, and that show, by way of illustration, specific configurations or examples. The drawings herein are not drawn to scale. Like numerals represent like elements throughout the several figures (which may be referred to herein as a “FIG.” or “FIGS.”).

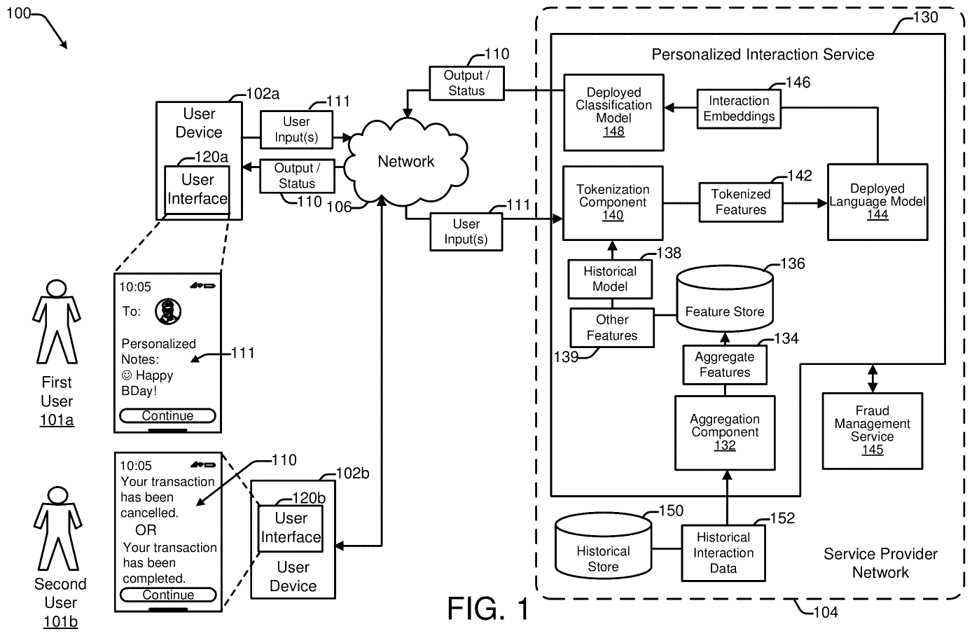

FIG. 1 illustrates an operating environment and several logical components provided by the technologies described herein. In particular, FIG. 1 is a diagram showing a system 100, according to one implementation.

System 100 is provided for illustration. In some implementations, the system 100 may include the same, fewer, more, or different elements configured in the same or different manner as that shown in FIG. 1.

The system 100 may include a first user device 102a associated with a first user 101a, a second user device 102b associated with a second user 101b, and a service provider network 104, connected via a network 106. Differing numbers of users and user devices may be operatively connected to the network 106 and/or in operation with the system 100. The first user device 102a and the second user device 102b may be referred to collectively as user devices 102. The first user 101a and the second user 101b may be referred to collectively as users 101.

The user devices 102 may include any suitable computing device, for example a personal computer (PC), point-of-sale (POS) terminal, mobile device (e.g., laptop, mobile phone, smart phone, table computer, netbook computer, etc.), network-connected television, audio/video componentry with Internet access, network-connected cable set-top box, network-connected audio/video device (e.g., HDMI-interfaced smart component configured to display video and provide audio to a television or monitor), automobile head-unit with network-access (e.g., car stereo or car console device), or other suitable device.

The user device 102a and 102b may be associated with a user (e.g., associated with the service provider) of the service provider network 104. The user device 102a may include one or more instances of a user interface 120a configured to execute thereon. Similarly, the user device 102b may include one or more instances of a user interface 120b configured to execute thereon. The user interface 120a and user interface 120b may be referred to collectively as user interfaces 120.

In some implementations, the user interfaces 120 include computer-executable code configured to implement the technologies as described herein. The user interfaces 120 may be configured to provide one or more graphical user interfaces (GUI), receive user inputs, display outputs (e.g., based on the described classifications, interruptions, etc.), and others.

For example, in some implementations, the user interface 120a is configured to present a GUI. The GUI may be configured to receive one or more user inputs 111. The user inputs 111 may include requests for personalized interactions with other users, such as the second user, through the service provider network 104. The requests for personalized interactions may include memorandums, text descriptions, and/or other personalization.

For example, many services may allow for a sender or recipient to associate personalized content (e.g., a message, description, design, sound, combination of the foregoing, or the like) that is associated with one or more interactions. The personalized content may include any suitable message, description, and/or design including text, emojis, stickers, backgrounds, images, videos, sound (e.g., music, speech, etc.), combinations of the forgoing, and others.

For example, the requests for personalized interactions may include text describing the interaction (e.g., “Happy Birthday, Ben! Here's $20”). For example, the requests for personalized interactions may include text describing a good (e.g., “new shoes”), a service (e.g., “dog walking fee”), or an activity (e.g., “funds for concert performance”). For example, the requests for personalized interactions may also include images (e.g., a picture of a good or service), emojis (e.g., smiley faces, hearts, leaves, grass, etc.), or other personalized descriptors.

The user inputs 111 may be transmitted to the service provider network 104 over the network 106. In some implementations, the user inputs 111 may be received by the service provider network 104 directly from the user device 102a.

In some implementations, network 106 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

The service provider network 104 may be a platform including one or more servers having one or more computing devices (e.g., a cloud computing system, cluster of physical servers, etc.). The service provider network 104 may be configured as a software-as-a-service (SaaS) platform, a financial services platform, a media content platform, a social networking platform, or as another computing platform configured to provide services to a variety of users.

The service provider network 104 may include one or more instances of a personalized interaction service 130 configured to received data from one or more deployed models 144.

The personalized interaction service 130 may include computer executable code configured to implement one or more of the technologies and/or techniques described herein. In some implementations, the personalized interaction service 130 is a back-end software service executing on one or more servers of the service provider network 104. In this example, the personalized interaction service 130 provides back-end service to the user interfaces 120, which serves as a front-end.

In some implementations, the personalized interaction service 130 is a functional back-end and front-end providing access to personalized interaction classifications for the service provider network as software-as-a-service (SaaS) platform. In this example, the personalized interaction service 130 may be accessible to the user devices 102 through a website, a mobile application, a desktop application, or other suitable program.

In some implementations, the personalized interaction service 130 provides the functionality of the user interfaces 120, as well as back-end functionality as described herein. In this example, the user interfaces 120 may be used interchangeably with the personalized interaction service 130.

In some implementations, the personalized interaction service 130 may receive historical interaction data 152 from historical data store 150. In some implementations, the historical interaction data 152 may include prior interactions for a user or recipient (personalized and non-personalized). In some implementations, the historical interaction data 152 may include prior personalized content on a per-user basis. For example, the prior personalized content may include any prior interaction data, for a particular user or recipient, including a message, description, and/or design including text, emojis, stickers, backgrounds, images, videos, sound (e.g., music, speech, etc.), combinations of the forgoing, and others.

In some implementations, historical data store 150 may be stored in a non-transitory computer readable memory (e.g., random access memory), a cache, a drive (e.g., a hard drive), a flash drive, a database system, or another type of component or device capable of storing data. The historical data store 150 may also include multiple storage components (e.g., multiple drives or multiple databases) that may also span multiple computing devices (e.g., across multiple server computers, in a distributed storage system, etc.).

In some implementations, the personalized interaction service 130 may train, update, adjust, and/or configure a deployed language model 144 and/or a deployed classification model 148 based on the historical interaction data 152. For example, the historical interaction data 152 may be used as training data, in some implementations. For example, a subset of the historical interaction data 152 may be used as training data, in some implementations.

In some implementations, the deployed language model 144 and the deployed classification model 148 may be jointly trained. In some implementations, the deployed language model 144 and the deployed classification model 148 maybe separately trained. In some implementations, the deployed language model 144 may be trained first, and the deployed classification model 148 may be trained subsequent to the deployed language model 144. Other variations in training may also be applicable.

After training and/or deployment, the deployed language model 144, the deployed classification model 148, and the personalized interaction service 130 may be operative to automatically classify new personalized interaction requests (e.g., and associated user inputs 111).

For example, the personalized interaction service 130 may include various components to effectuate automatic classification. The personalized interaction service 130 may include an aggregation component 132, a feature data store 136, a tokenization component 140, as well as the deployed language model 144 and the deployed classification model 148.

The aggregation component 132 may be a software component configured to aggregate a subset of the historical interaction data 152 that is associated with an initiating user (e.g., illustrated here as the first user). The subset may be based on recency, time period, amount, a combination of the foregoing, and/or the like.

In some implementations, the subset of the historical interaction data 152 may be a subset including a number of recent personalized interactions associated with a user, for example, approximately fifty prior personalized interactions associated with a user (e.g., the initiating user, the receiving user, and/or a combination of both users. In some implementations, the subset of the historical interaction data 152 may be a subset including between ten and fifty prior personalized interactions associated with the initiating user and/or the receiving user. In some implementations, the subset of the historical interaction data 152 may be a subset including between fifty and one hundred prior personalized interactions associated with the initiating user and/or the receiving user. Other amounts, including more or fewer prior personalized interactions, may be included for the subset of the personalized interactions.

In some implementations, the subset of the historical interaction data 152 may be a subset including a number of personalized interactions within a designated period of time, for example, approximately sixty days' worth of personalized interactions associated with the initiating user and/or the receiving user. In some implementations, the subset of the historical interaction data 152 may be a subset including between thirty- and sixty-days' worth of personalized interactions associated with the initiating user and/or the receiving user. In some implementations, the subset of the historical interaction data 152 may be a subset including between sixty- and ninety-days' worth of personalized interactions associated with the initiating user and/or the receiving user. Other time scales, including more or fewer day's worth of personalized interactions may be included for the subset of personalized interactions.

The aggregation component 132 may be operative to generate a set of aggregate features 134 from the subset of the historical interaction data 152. For example, the aggregation components 132 may receive the historical interaction data 152, create two or more copies of individual interactions within the historical interaction data 152 (e.g., a sender copy and a receiver copy), filter interactions that do not contain personalized data (e.g., that do not contain personalized: memos, descriptions, images, text, or other additional information), and aggregates the filtered interactions to create aggregate features 134.

The aggregate features 134 may include a serialized string or string of objects representing the filtered interactions. The aggregate features 134 may be stored in the feature data store 136.

In some implementations, feature data store 136 may be stored in a non-transitory computer readable memory (e.g., random access memory), a cache, a drive (e.g., a hard drive), a flash drive, a database system, or another type of component or device capable of storing data. The feature data store 136 may also include multiple storage components (e.g., multiple drives or multiple databases) that may also span multiple computing devices (e.g., across multiple server computers, in a distributed storage system, etc.).

The tokenization component 140 may receive as input a historical model 138 associated with the initiating user (illustrated here as the first user) and/or other features 139 associated with the pending personalized interaction or user inputs 111. For example, the tokenization component 140 may be configured to retrieve or request the historical model 138 and/or the other features 139 from the feature data store 150.

The tokenization component 140 may be operative to input a non-standard input and output a standard output. In some implementations, the tokenization component 140 may be operative to translate images, emojis, and other non-textual data into text. For example, the tokenization component may replace emojis from the historical model with one or more text words (e.g., “heart” for a heart emoji, “smile” for a smiley emoji, “leaf” for a leaf emoji, “green circle” for a green circle emoji, and so on). In some implementations, the tokenization component 140 may be operative to extract features from visual content such as images, animations, movies, clips, or other visual data, and translate the extracted features into text (e.g., a clip of a dog dancing may be translated to “dancing dog,” an image of a cat with a smile may be translated to “smiling cat,” and others). In some implementations, the tokenization component 140 may be operative to extract features from audio content such as songs, music clips, and other audio data, and translate the extracted features into text (e.g., a portion or entirety of song lyrics may be extracted and translated, a portion or entirety of spoken words may be extracted and translated, a musical genre may be extracted and translated, and others).

Thereafter, the tokenization component 140 may tokenize the historical model 138 into a variable length embedding representation and output the variable length embedding representation as tokenized features 142.

The tokenized features 142 may include a set of representations (one for the sender, one for the recipient, and one representing the other features 139) containing variable length representations and a mask (e.g., an attention mask). For example, the representations (including variable length representations and others) may be a tensor, in some implementations. For example, the representations may also include other representations for interrelations between logical objects. For example, the mask may mask off portions of the variable length representations in some implementations.

The deployed language model 144 may input the tokenized features 142 and output interaction embeddings 146. In some implementations, the deployed language model 144 may be a transformer-based language model. In some implementations, the deployed language model 144 may be a large-language model. In some implementations, the deployed language model 144 may be a bidirectional encoder representations from transformers (BERT) model.

In some implementations, the deployed language model 144 may generate the interaction embeddings 146 by making an inference for both the sender representation and receiver representation (e.g., based on the included mask), extract embeddings from a last hidden state for each input token, and concatenate the representations that represent the other features 139 and the historical model 138 into a single representation output as the interaction embeddings 146. It is noted that the interaction embeddings 146 represent the personalized features extracted from the historical interaction data 152 (e.g., personalized: memos, text, images, emojis, etc.) and represent the other features 139. The single representation output of the interaction embeddings 146 may be provided as input to the deployed classification model 148.

The deployed classification model 148 may input the interaction embeddings 146 and output a classification for the pending interaction or user inputs 111. In some implementations, the deployed classification model 148 may be a tree-based model. In some implementations, the deployed classification model 148 may be a light gradient boosting machine (LGBM) based model. Other tree-based decision and classification models may also be applicable, in some implementations. The deployed classification model 148 may output a classification based on the input interaction embeddings 146.

Classifications can represent user account types (e.g., a super user account, an ambassador, a fraudulent user account, a non-compliant user account, etc.) or other characteristics associated with user accounts. For example, if the user inputs 111 are classified as originating from a “super user” or “ambassador,” the personalized interaction service 130 may complete the interaction and/or provide feedback to the user, additional options or functionality to the user, or the like. For example, if the user inputs 111 are classified as non-suspicious or non-violating, the personalized interaction service 130 may complete the interaction. For example, if the user inputs 111 are classified as related to a fraudulent, policy-violating, or term-violating interaction, the personalized interaction service 130 may interrupt further processing of the pending interaction.

In some implementations, the interruption may include an output/status 110 for display to one or both of the first and second user that the interaction was interrupted or cancelled. In some implementations, the interruption may include further processing by a fraud management service 145 to alert, notify, or otherwise manage the fraudulent and/or policy-violating interaction request.

For example, the fraud management service 145 may be an escalation service to escalate the pending interaction for further review (e.g., hold transaction until human review is conducted and satisfactory), report the pending interaction, or perform further restrictions to one or both of the first and second user's accounts at the service provider network 104. Other variations on escalation are also applicable in some implementations.

Hereinafter, functionality associated with the above-described operating environment is described in detail.

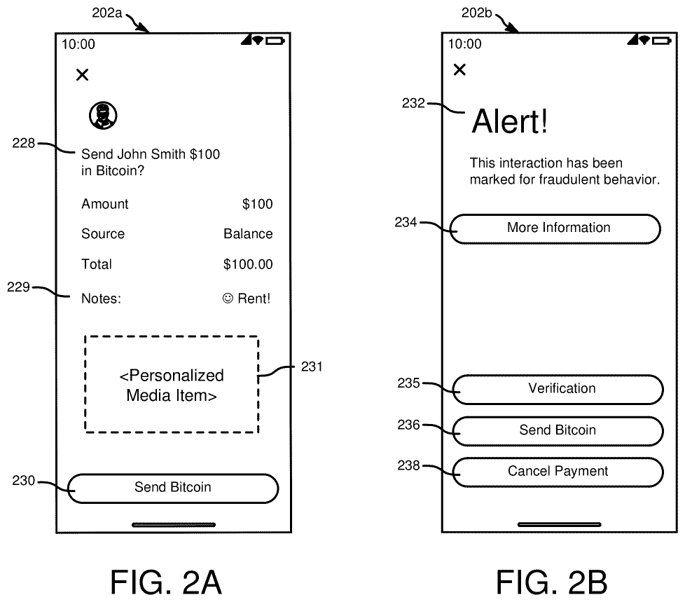

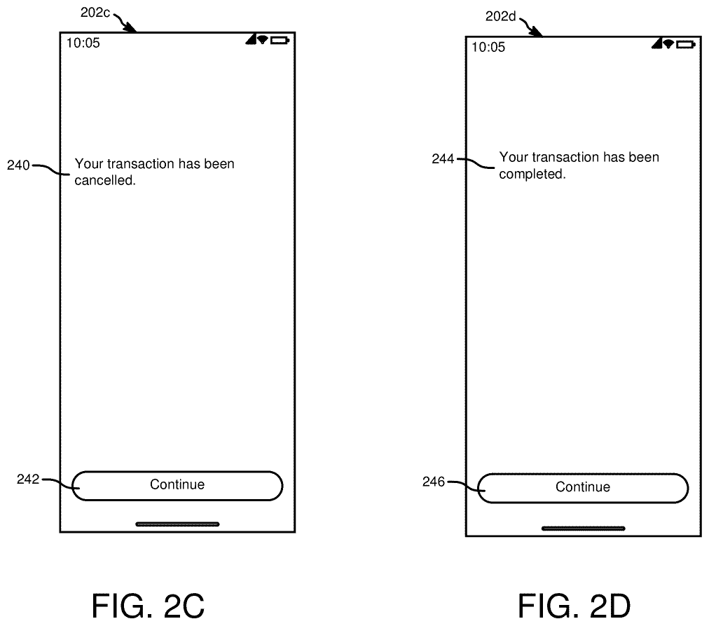

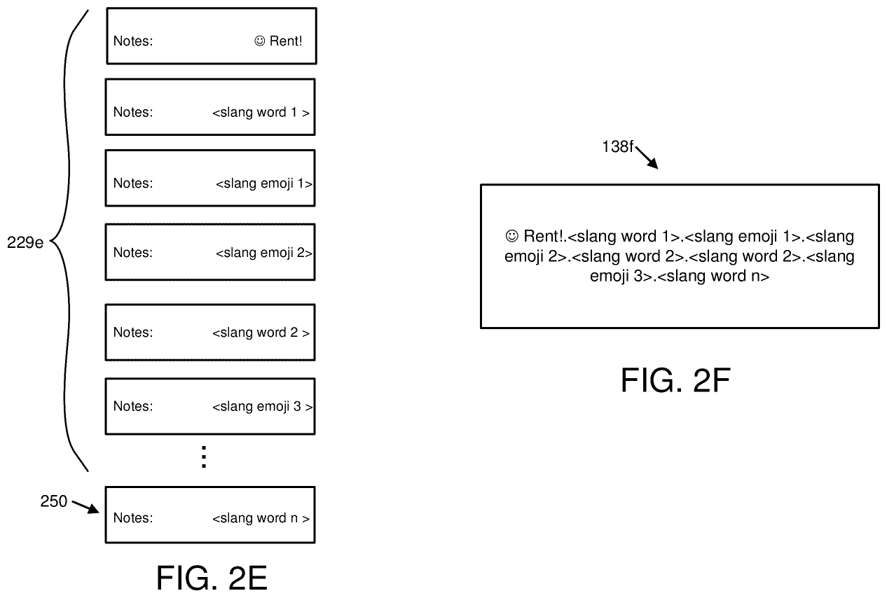

FIG. 2A is a schematic of an example user interface 202a depicting a personalized interaction, according to an implementation presented herein. FIG. 2A illustrates a user interface 202a including a transaction prompt 228, an interaction personalization element 229, an activatable user interface element 230, and an additional interaction personalization element 231. The first user 101a may attempt to perform a transaction to send funds to a destination address (or other recipient data) associated with a second user 101b. The transaction prompt 228 may include a destination address, an account associated with the destination address or information identifying the account, an amount associated with the transaction, a source for the transaction, and a total corresponding to the transaction. In some examples, the activatable link associated with transaction may auto-populate one or more fields of the transaction prompt 228.

The first user 101a may input user inputs 111 in the interaction personalization element 229 (e.g., “ [symbol] rent!”). The first user 101a may also input additional personalization such as images, stamps, graphics, sounds, or others, at the additional interaction personalization element 231. In some implementations, the additional interaction personalization element 231 includes a graphic such as a personalized stamp, picture, image, or other personalization.

The first user 101a may select the activatable user interface element 230 to perform the transaction associated with the transaction prompt 228. In response to selecting the activatable user interface element 230, the user interface 202a can transition to user interface 202b as shown in FIG. 2B.

FIG. 2B is a schematic of an example user interface depicting an interrupted personalized interaction, according to an implementation presented herein.

User interface 202b includes an intervention regarding the requested transaction. In particular, the user interface 202b includes an alert 232 and activatable user interface elements 234, 235, 236, and 238. In some examples, the personalized interaction service 130 may classify an interaction as fraudulent, policy-violating, term-violating, or otherwise suspicious. The alert 232 may provide a notification to the first user 101a that the interaction has been marked as suspicious or fraudulent. The activatable user interface element 234 may be selected to access more information corresponding to the alert 232. As an example, the personalized interaction service 130 may provide additional information corresponding to how or why the interaction has been flagged as suspicious. The activatable user interface element 235 may be selected to request escalation or verification of the personalized interaction. Selecting activatable user interface element 235 may initiate a process for intervention by other automated components (e.g., such as the fraud management service 145) or by human intervention, in an attempt to allow the interaction (e.g., if the user believes it is not a fraudulent or policy-violating interaction). The activatable user interface element 236 may be selected to attempt to complete the transaction despite the alert 232, after any escalation process concludes successfully. For example, the element 236 may be selectable if the escalation was successful, in some implementations. The activatable user interface element 238 may be selected cancel the interaction.

In response to the first user 101a selecting activatable user interface element 238, the user interface 202b can transition to user interface 202c as shown in FIG. 2C.

FIG. 2C is a schematic of an example user interface depicting a cancelled personalized interaction, according to an implementation presented herein. The user interface 202c may include a prompt 240 and an activatable user interface element 242. The prompt 240 may indicate the interaction the first user 101a initiated was cancelled. The activatable user interface element 242 may be selected to return to either a home screen of a GUI or another user interface where the first user 101a may input details to perform another interaction.

In response to the first user 101a selecting activatable user interface element 236, the user interface 202b can transition to user interface 202d as shown in FIG. 2D.

FIG. 2D is a schematic of an example user interface depicting a completed personalized interaction, according to an implementation presented herein. The user interface 202d may include a prompt 244 and an activatable user interface element 246. The prompt 244 may indicate that the interaction has been successfully completed. The activatable user interface element 246 may be selected to return to either a home screen of GUI or another user interface where the first user 101a may input details to perform another transaction.

As described above, various user interfaces may be provided to effectuate personalized interactions.

FIGS. 2E and 2F depict the aggregation of user inputs 111, for example, for generating a historical model for a user. For example, the user interfaces 202 may include elements for inputting user inputs 111 as personalized features for processing, tokenization, and classification as described herein. Upon storage of historical interaction data that is based upon prior interactions 229e, a component may aggregate and create a historical model 138f based upon a subset of the prior interactions 229e.

For example, prior interactions 229e may represent a series of prior historical interactions between a sender and one or more recipients. Upon receipt of a new interaction request with a new personalized interaction 250, an aggregation component (e.g., such as component 132) or a feature data store (e.g., such as data store 136) may output a historical model 138f that includes the prior interaction data 229e as well as the new interaction request data 250. In some implementations, the aggregation component or data store provides a historical model including the historical interaction data 229e and not the new interaction request data 250 (e.g., the new interaction request data 250 may instead be processed by a tokenization component or other competent).

In the examples illustrated in FIG. 2E and FIG. 2F, the sending user has used a series of slang terminology (e.g., terminology intended to have more than one meaning) as well as slang emojis (e.g., emojis that may have alternative meanings) in a series of prior personalized interactions. While a series of slang words/terms and emojis are references, the sending user may include any word, emoji, phrase, text, image, sound, video, background, and/or the like, which may or may not have multiple meanings. The historical model 138f is built from the prior interaction data 229e such that these prior interactions are input as an aggregated input into deployed models at a service provider network.

For example, a tokenizer may input the historical model 138f (as well as new interaction request data 250). The tokenizer may interpret and/or translate any non-textual data and assemble a single input to a language model. The single input is structured as a string of tokenized features extracted from the historical model 138f. The single input includes the new interaction request data 150 concatenated, added, or otherwise combined with the features extracted from the historical model 138f.

A deployed language model (e.g., model 144) may input the single input, and output interaction embeddings that include embeddings representing the historical model 138f and new interaction request data 250. A deployed classification model (e.g., model 148) may, in response to input of the interaction embeddings, output a classification for the new interaction request as a classification based upon the prior interaction data 229e as well as the new interaction request data 250, without requiring a plurality of real-time input signals or other data.

In the examples of FIGS. 2E and 2F, if the slang words and/or slang emojis result in a classification that results in interruption, the service provider network may interrupt the pending interaction (e.g., based on the new interaction request and data 250) such that a violation of terms, violation of policy, violation of compliance, illegal activity, fraudulent activity, and/or other classifications do not result in completion of the personalized interaction.

Accordingly, implementations described herein overcome drawbacks such as increased bandwidth and increased computational resource usage through the aggregated historical interaction data, as a single input is provided to a deployed model and a single output is obtained, thereby reducing data transmission and computational cycles to process the reduced data transmissions. Moreover, the techniques described herein are scalable such that classification of a plurality of different interactions may be classified in substantially real-time, while reducing computing resources and network bandwidth associated with conventionally large, specialized models that rely on multiple real-time input signals.

For example, as the prior interaction data 229e is obtainable for virtually any user with prior interactions, a historical model may be readily built for virtually any user, with new interaction requests being appended, added, or otherwise combined with the historical model of a particular user. As the single input is a relatively small data size of tokenized features extracted from translated text, these techniques are scalable to a plurality of users without suffering drawbacks associated with deployment of multiple models having multiple real-time signal inputs, and overall architecture considerations during scaling may be simplified.

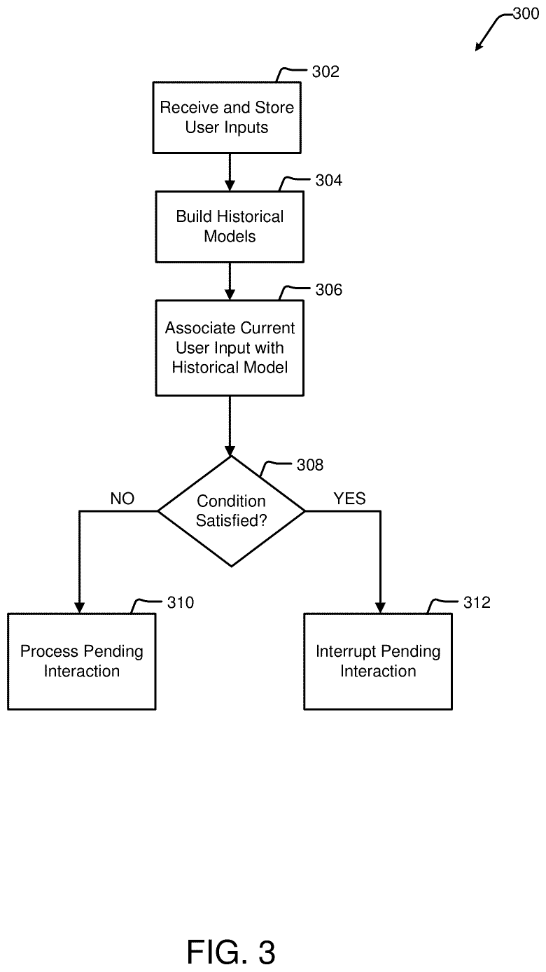

Hereinafter, methods of automatic classification of personalized interactions are described more fully with reference to FIGS. 3-5.

FIG. 3 is a flowchart showing aspects of a method 300 of classification of personalized interactions based on a fraud condition, according to an implementation presented herein. In some implementations, method 300 may be executed by one or more components of the service provider network 104 and/or system 100. Method 300 can be performed (or repeated) in a different order than described herein and/or one or more blocks can be omitted and/or one or more additional functions may be added without departing from the scope of this disclosure. Additionally, portions of the method 300 may be rearranged and/or combined with other methods without departing from the scope of this disclosure. Furthermore, portions of the method 300 may be combined and performed in sequence or in parallel, according to specific implementations, and without departing from the scope of this disclosure. Method 300 may begin at block 302.

At block 302, user inputs are received and stored. For example, the user inputs (e.g., similar to user inputs 111) may be received and stored by a service provider network (e.g., 104) or a personalized interaction service (e.g., 130). The user inputs may be associated with interactions between users of an application. For example, the application may include a payment application, a P2P application, or another interaction application where users may request a transaction be processed and include personalized elements (e.g., such as notes, memos, descriptions, emojis, etc.). Accordingly, the personalized interactions may include at least one of: personalized payments, peer-to-peer payments, cash card transactions, and payment application transactions.

In some implementations, the user inputs include one or more personalized descriptions of an interaction, the personalized descriptions including at least one of: text, image, and emoji. Block 302 may be followed by block 304.

At block 304, historical models are built based on the user inputs. The historical models may be built by aggregating particular user inputs associated with a set of previous interactions between a particular user and other users.

In some implementations, the set of previous interactions may be a subset including approximately fifty prior personalized interactions associated with the initiating user. In some implementations, the set of previous interactions may be a subset including between ten and fifty prior personalized interactions associated with the initiating user. In some implementations, the set of previous interactions may be a subset including between fifty and one hundred prior personalized interactions associated with the initiating user. Other amounts, including more or fewer prior personalized interactions, may be included for the subset of the personalized interactions.

In some implementations, the set of previous interactions may be a subset including approximately sixty days' worth of personalized interactions associated with the initiating user. In some implementations, the set of previous interactions may be a subset including between thirty- and sixty-days' worth of personalized interactions associated with the initiating user. In some implementations, the set of previous interactions may be a subset including between sixty- and ninety-days' worth of personalized interactions associated with the initiating user. Other time scales, including more or fewer days' worth of personalized interactions may be included for the subset of personalized interactions.

In some implementations, an aggregation component (e.g., 132) may perform the aggregating and building.

In some implementations, aggregating the user inputs includes aggregating data associated with previous interactions between the particular user and the other users within a time window that includes the pending interaction. Additionally, one or more previous interactions associated with a respective timestamp within the time window are included in the aggregating and previous interactions associated with timestamps outside the time window are excluded in the aggregating.

In some implementations, aggregating the user inputs includes aggregating data associated with a configurable number of previous interactions between the particular user and the other users. Additionally, the configurable number maybe ten, fifty, or one hundred, in some implementations.

Additionally, the historical models may be stored at a service provider network for other classifications. Block 304 may be followed by block 306.

At block 306, the current user input is associated with the historical model for a particular user. In some implementations, associating the current user input with the historical model includes generating an aggregated feature set. For example, the aggregated feature set may be generated by a tokenization component (e.g., 140) that is configured to aggregate features from the historical model and features from the user inputs associated with the pending interaction. The aggregated feature set may be a set of tokenized features (e.g., 142) that may be input into a language model (e.g., 144). In some implementations, the language model outputs interaction embeddings (e.g., 146). The interaction embeddings may include both prior interaction embeddings as well as one or more embeddings associated with the pending interaction.

Furthermore, as some descriptions in prior interactions and pending interactions may include visual data (e.g., images, emojis, etc.), block 306 may also include translating visual data or emoji data in the user inputs and prior interactions into translated text, and tokenizing the translated text into the aggregated feature set.

Block 306 may be followed by block 308.

At block 308, a determination is made whether the pending interaction satisfies a classification condition. In some implementations, the determination may be based on analyzing the historical model with a classification model to determine if the classification condition is met or exceeded.

For example, the classification condition may be a classification output value satisfying or exceeding a threshold. The classification may be output by a classification model (e.g., 148) and may be a numerical value. In some implementations, the numerical value may be between zero and one. In some implementations, the numerical value may be between zero and ten. In some implementations, the numerical value may be between zero and one hundred. The classification threshold may be a threshold chosen such that interactions falling below the threshold are predicted to be compliant or non-suspicious, while interactions satisfying or exceeding the threshold are predicted to by policy-violating interactions. Other variations on the classification condition may be applicable, including other numerical values, binary classifications, and others.

It is noted that blocks 306 and 308 may be performed in association with a pending interaction for the particular user and during the pending interaction, and/or in substantially real-time. For example, the associating and determining may occur during the pendency of the interaction at a service provider network. In this manner, interactions may be interrupted prior to final processing. As such, processing of fraudulent or suspicious interactions may be reduced and computational resource usage may also be reduced.

If the classification condition is not satisfied, block 308 may be followed by block 310. Else, block 308 may be followed by block 312.

At block 310 (e.g., if the interaction is not policy-violating), the pending interaction and/or current interaction may be processed by a service provider network (e.g., 104) or a personalized interaction service (e.g., 130).

At block 312 (e.g., if the interaction is policy-violating or suspicious), the pending interaction and/or current interaction may be interrupted.

In some implementations, interrupting the pending personalized interruption includes at least one of: flagging the pending personalized interaction for further review, denying the pending personalized interaction, cancelling the pending personalized interaction, and pausing the pending personalized interaction. Other variations may also be applicable.

In some implementations, if the pending interaction is interrupted, one or more additional processes may be performed. In some implementations, the additional processes may include a compliance review, a fraud management review (e.g., with service 145), further verification of users associated with the pending interaction, and others. In some implementations, the additional processes may include restrictions on users associated with the pending interaction and/or flagging accounts associated with the users as suspicious or related to policy-violating or fraudulent behavior. Other additional processes may also be implemented in some implementations, including overriding of the classification at block 308 through a manual review or verification process.

As described above, a method of classification of personalized interactions may include receiving and storing user inputs associated with interactions between users of an application, building historical models based on the user inputs to classify the interactions, associating a current user input with the historical model for the particular user, based on analyzing the historical model for the particular user, determining that the pending interaction satisfies a condition, and interrupting the pending interaction based on determining that the pending interaction satisfies the condition.

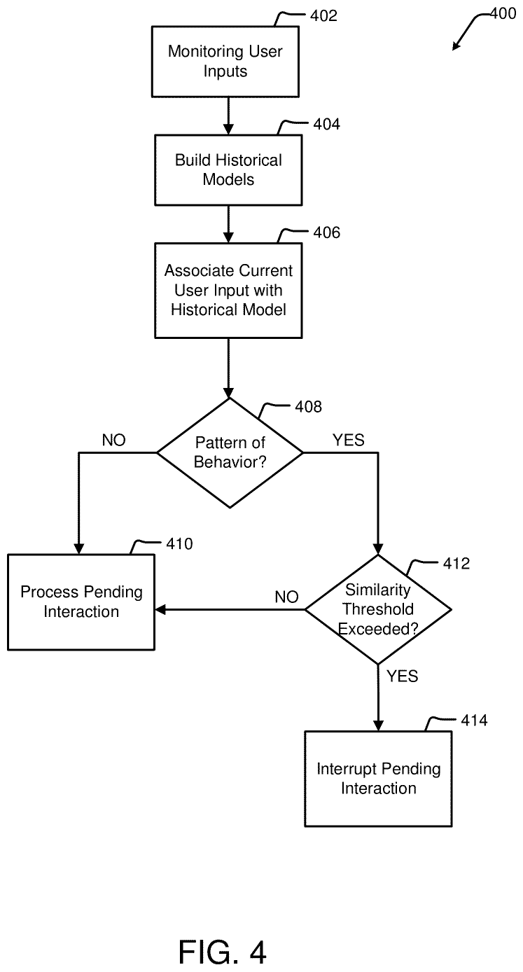

Through method 300, a technique is described which reduces computational resources used for classification of pending interactions while also reducing network bandwidth associated with additional signals that conventional classification algorithms rely upon. Hereinafter, an additional method of classification of personalized interactions is described with reference to FIG. 4.

FIG. 4 is a flowchart showing aspects of a method 400 of classification of personalized interactions based on a fraud pattern, according to an implementation presented herein. In some implementations, method 400 may be executed by one or more components of the service provider network 104 and/or system 100. Method 400 can be performed (or repeated) in a different order than described herein and/or one or more blocks can be omitted and/or one or more additional functions may be added without departing from the scope of this disclosure. Additionally, portions of the method 400 may be rearranged and/or combined with other methods without departing from the scope of this disclosure. Furthermore, portions of the method 400 may be combined and performed in sequence or in parallel, according to specific implementations, and without departing from the scope of this disclosure. Method 400 may begin at block 402.

At block 402, user inputs are monitored. For example, the user inputs (e.g., similar to user inputs 111) may be monitored (and/or received and stored) by a service provider network (e.g., 104) or a personalized interaction service (e.g., 130). The user inputs may be associated with interactions between users of an application. For example, the application may include a payment application, a P2P application, or another interaction application where users may request a transaction be processed and include personalized elements (e.g., such as notes, memos, descriptions, emojis, etc.). Therefore, personalized interactions may include at least one of: personalized payments, peer-to-peer payments, cash card transactions, and payment application transactions. Block 402 may be followed by block 404.

At block 404, historical models are built based on the user inputs. The historical models may be built by aggregating particular user inputs associated with a set of previous interactions between a particular user and other users.

In some implementations, the set of previous interactions may be a subset including approximately fifty prior personalized interactions associated with the initiating user. In some implementations, the set of previous interactions may be a subset including between ten and fifty prior personalized interactions associated with the initiating user. In some implementations, the set of previous interactions may be a subset including between fifty and one hundred prior personalized interactions associated with the initiating user. Other amounts, including more or fewer prior personalized interactions, may be included for the subset of the personalized interactions.

In some implementations, the set of previous interactions may be a subset including approximately sixty days' worth of personalized interactions associated with the initiating user. In some implementations, the set of previous interactions may be a subset including between thirty- and sixty-days' worth of personalized interactions associated with the initiating user. In some implementations, the set of previous interactions may be a subset including between sixty- and ninety-days' worth of personalized interactions associated with the initiating user. Other time scales, including more or fewer days' worth of personalized interactions may be included for the subset of personalized interactions.

In some implementations, an aggregation component (e.g., 132) may perform the aggregating and building. In some implementations, aggregating the user inputs includes aggregating data associated with previous interactions between the particular user and the other users within a time window that includes the pending interaction. Additionally, one or more previous interactions associated with a respective timestamp within the time window are included in the aggregating and previous interactions associated with timestamps outside the time window are excluded in the aggregating.

Additionally, the historical models may be stored at a service provider network for other classifications. Block 404 may be followed by block 406.

At block 406, the current user input is associated with the historical model for a particular user. In some implementations, associating the current user input with the historical model includes generating an aggregated feature set. For example, the aggregated feature set may be generated by a tokenization component (e.g., 140) that is configured to aggregate features from the historical model and features from the user inputs associated with the pending interaction. The aggregated feature set may be a set of tokenized features (e.g., 142) that may be input into a language model (e.g., 144). In some implementations, the language model outputs interaction embeddings (e.g., 146). The interaction embeddings may include both prior interaction embeddings as well as one or more embeddings associated with the pending interaction.

Furthermore, as some descriptions in prior interactions and pending interactions may include visual data (e.g., images, emojis, etc.), block 406 may also include translating visual data or emoji data in the user inputs into translated text, and tokenizing the translated text into the aggregated feature set.

Block 406 may be followed by block 408.

At block 408, a determination is made whether the aggregated feature set includes an identifiable pattern of personalized interactions that satisfy a condition. For example, the pattern condition may be pattern of behavior that indicates one or more prior interactions are associated with policy-violating behavior. In this example, the identifiable pattern is a classification output by a deployed classification model (e.g., model 148). In this example, the identifiable pattern is a pattern that will associate a new interaction request as being a request that may be interrupted. For example, the pattern condition may be a pattern of behavior that indicates that one or more prior interactions are associated with fraud, risk, or other violations that exceed a threshold for fraud or risk. Accordingly, in some implementations, a deployed classification model determines whether a history of personalized interactions (in conjunction with other features) is suspicious or not (i.e., is within a threshold similarity of a pattern of suspicious behavior), for a specific classification task. Other variations may also be applicable.

If the pattern condition is not satisfied, block 408 may be followed by block 410. Else, block 408 may be followed by block 412.

At block 410 (e.g., if the prior interactions do not establish a pattern of violations), the pending interaction and/or current interaction may be processed by a service provider network (e.g., 104) or a personalized interaction service (e.g., 130).

At block 412 (e.g., if the prior interactions do establish a pattern of violations), a determination is made whether the pending personalized interaction meets or exceeds a threshold similarity value to the identified pattern. For example, the threshold similarity value may include any suitable threshold value for similarity. In this example, the deployed classification model (e.g., model 148) may further determine whether the pending personalized interaction meets or exceeds the similarity value. In some implementations, an additional model or component may be deployed to compare the classified pattern with the pending interaction request.

If the similarity threshold is not met or not exceeded, block 412 is followed by block 410, where the interaction may be processed. Else, block 412 is followed by block 414.

At block 414 (e.g., if the pending interaction meets or exceed the similarity threshold) the pending interaction and/or current interaction may be interrupted.

In some implementations, interrupting the pending personalized interruption includes at least one of: flagging the pending personalized interaction for further review, denying the pending personalized interaction, cancelling the pending personalized interaction, and pausing the pending personalized interaction. Other variations may also be applicable.

In some implementations, if the pending interaction is interrupted, one or more additional processes may be performed. In some implementations, the additional processes may include a compliance review, a fraud management review (e.g., with service 145), further verification of users associated with the pending interaction, and others. In some implementations, the additional processes may include restrictions on users associated with the pending interaction and/or flagging accounts associated with the users as suspicious or related to policy-violating or fraudulent behavior. Other additional processes may also be implemented in some implementations, including overriding of the classification at block 308 through a manual review or verification process.

As described above, a method of classification of personalized interactions may include monitoring user inputs associated with personalized interactions between a first user of an application and other users of the application, building a historical model for the first user based on the monitored user inputs to classify the personalized interactions, associating a new user input with the historical model to generate an aggregated feature set, analyzing the aggregated feature set to identify a pattern of personalized interactions that satisfy a condition, determining that the pending personalized interaction exceeds a threshold similarity value to the identified pattern, and interrupting the pending personalized interaction based on determining that the pending personalized interaction exceeds the threshold similarity value.

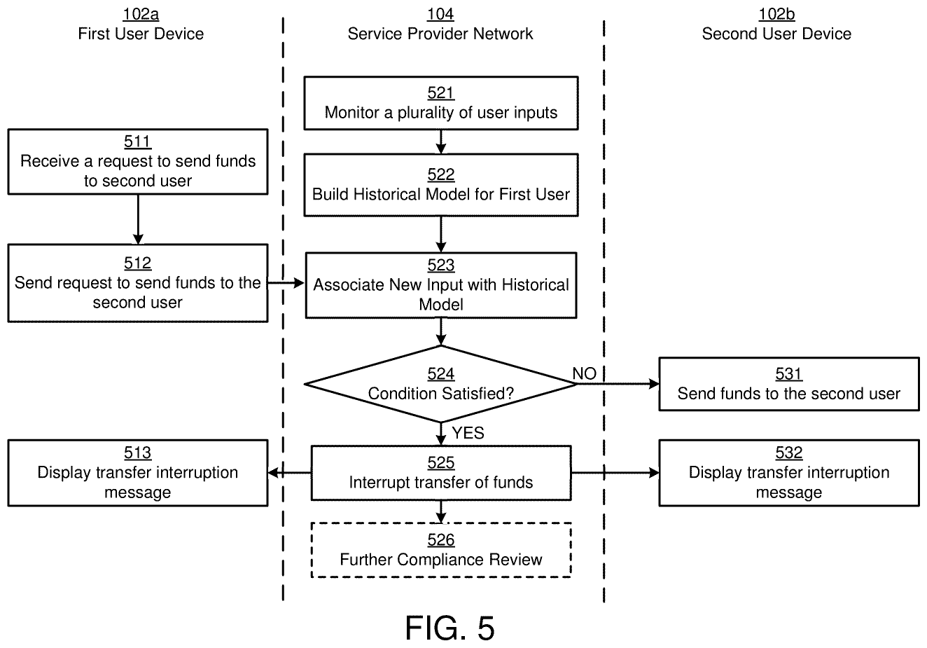

Through method 400, a technique is described which reduces computational resources used for classification of pending interactions while also reducing network bandwidth associated with additional signals that conventional classification algorithms rely upon. Hereinafter, an additional method of classification of personalized interactions is described with reference to FIG. 5.

FIG. 5 is a diagram showing aspects of a method 500 of classification of personalized interactions, according to an implementation presented herein. In some implementations, method 500 may be executed by one or more components of the service provider network 104 and/or system 100. Method 500 can be performed (or repeated) in a different order than described herein and/or one or more blocks can be omitted and/or one or more additional functions may be added without departing from the scope of this disclosure. Additionally, portions of the method 500 may be rearranged and/or combined with other methods without departing from the scope of this disclosure. Furthermore, portions of the method 500 may be combined and performed in sequence or in parallel, according to specific implementations, and without departing from the scope of this disclosure.

As shown in FIG. 5, a first user device 102a may receive a request to send funds to a second user, at block 511. The request may be input through a GUI similar to GUI 202a. Thereafter, the request is sent to service provider network 104, at block 512. For example, the request may be transmitted over network 106.

Separately, the service provider network 104 may monitor a plurality of user inputs at block 521. The monitoring may include monitoring, receiving, and storing user inputs as described above. Using the monitored user inputs, the service provider network 104 may build a historical model for the first user at block 522. For example, the historical model may be built similar to blocks 304 and 404, described above.

Upon creation of the historical model, and receipt of the user request from block 512, the service provider network may associate the new input (e.g., from block 512) with the historical model, at block 513. For example, the associating may include generating an aggregated feature set (e.g., 142).

The service provider network 104 may then determine whether a classification condition is satisfied at block 524. For example, the classification condition may be similar to the classification condition described above with reference to block 308, or may be a combination of determinations similar to blocks 408 and 412.

If the classification condition is not satisfied (e.g., the pending interaction does not violate policy), the funds associated with the request of block 511 are sent to the second user 101b, at block 531.

If the classification condition is satisfied (e.g., the pending interaction violates policy), the service provider network 104 interrupts transfer of funds at block 525, and may cause display of transfer interruption messages at blocks 513 and 532. For example, the display of transfer interruption messages may be similar to alert 232 in GUI 202b.

In some implementations, an interrupted interaction may result in a transfer interruption message to be displayed at a GUI of the sending user (e.g., block 513). In this example, a recipient user may not be notified of an attempted interaction, for example if the interaction was blocked or interrupted in real time or otherwise interrupted prior to processing. In another example, the interrupted interaction may result in a transfer interruption message to be displayed at a GUI of the recipient user (e.g., block 532) as well as the sending user. In this example, the interruption may be performed post-completion and therefore the recipient may be notified that a previously processed interaction was cancelled or otherwise interrupted. Variations on notifications may be applicable depending upon particular scenarios, types of interactions, available user interaction history, as well as user input associated with a current or pending interaction.

After interruption of fund transfer (or at substantially the same time), the service provider network may forward the request from block 511 for further compliance review or further processing, at block 526.

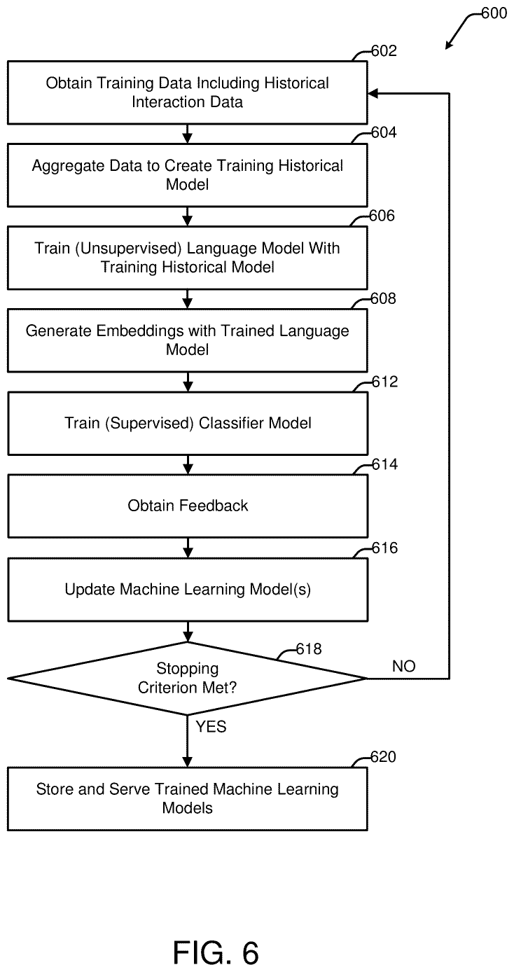

As described above, various methods of classification of personalized interactions provide automated classification based on historical models built for a particular user as well as a currently pending interaction. The classification and historical models are output by deployed models at a service provider network, which may include a classification model and a language model. Hereinafter, a method of training a classification model and a language model are described with reference to FIG. 6.

FIG. 6 is a flowchart of a method 600 of training of a language model and a classification model, according to an implementation presented herein. In some implementations, method 600 may be executed by one or more components of the service provider network 104 and/or system 100. Method 600 can be performed (or repeated) in a different order than described herein and/or one or more blocks can be omitted and/or one or more additional functions may be added without departing from the scope of this disclosure. Additionally, portions of the method 600 may be rearranged and/or combined with other methods without departing from the scope of this disclosure. Furthermore, portions of the method 600 may be combined and performed in sequence or in parallel, according to specific implementations, and without departing from the scope of this disclosure. Method 600 may begin at block 602.

At block 602, training data comprising a plurality of records is obtained. In some implementations, records in the training data includes historical interaction data 152. Block 602 may be followed by block 604.

At block 604, the training data is aggregated by aggregation component 132 to create a historical model for training. Block 604 may be followed by block 606.

At block 606, the language model 144 is trained in an unsupervised manner using the historical model. For example, masked language modeling (MLM) may be used in training the language model. ML is a technique where a portion of input tokens from the historical model are randomly masked and the model under training predicts the original tokens. The MLM technique trained the language model 144 to ascertain contextual relationships in the provided text (e.g., the personalization text, emoji translations, audio translations, video translations, image translations, etc.). Block 606 may be followed by block 608.

At block 608, embeddings are generated by the trained language model. For example, the generated embeddings may be similar to interaction embeddings 146 but absent a pending transaction or interaction as part of the embeddings. Block 608 may be followed by block 612.

At block 612, the classification model 148 is trained in a supervised manner. For example, the generated embeddings may be input to the classification model for training. Block 612 may be followed by block 614.

At block 614, feedback is obtained for the model or component in training based on the generated embeddings at block 608 and/or the training at blocks 606 and 612. In some implementations, feedback may be generated based on the user input in individual records in the training data and corresponding output. For example, the feedback may be obtained from a feedback generator based on the user input and the output in the record. In some implementations, the feedback generator may include a hard-coded loss function. Block 614 may be followed by block 616.

At block 616, the models or components under training may be updated based on the generated feedback. For example, one or more parameters, weights, values, and/or architecture details may be updated based on the generated feedback. It is noted that both of blocks 614 and 616 may also be executable as sub-operations associated with either or both of blocks 612 and 606, in some implementations. Block 616 may be followed by block 618.

At block 618, it is determined if a stopping criterion for model or component training has been met. For example, if a threshold number of records have been evaluated from the training dataset (e.g., 100 records, 1,000 records, 10,000 records, etc.), it may be determined that the stopping criterion has been met. In another example, an evaluation of the model output (the generated output and training input) may be performed and if the model has reached a threshold level of accuracy, it may be determined that the stopping criterion has been met. In some implementations, combinations of different stopping criteria may be used.

If the stopping criterion has been met, block 618 is followed by block 620. Else, block 618 is followed by block 602, where additional training data is obtained.

At block 620, the trained models or components are stored and/or deployed at the service provider network, e.g., network 104.

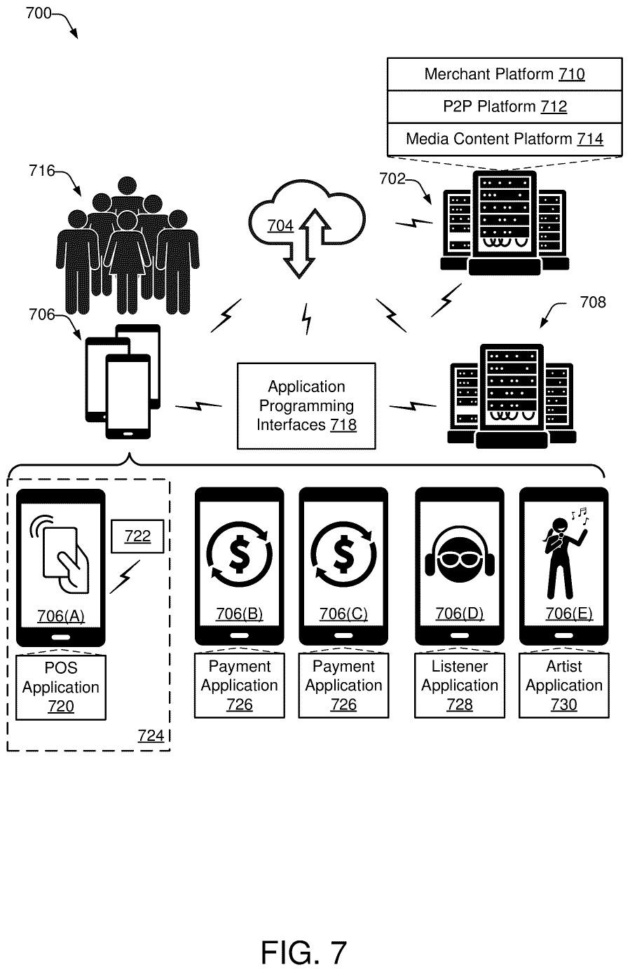

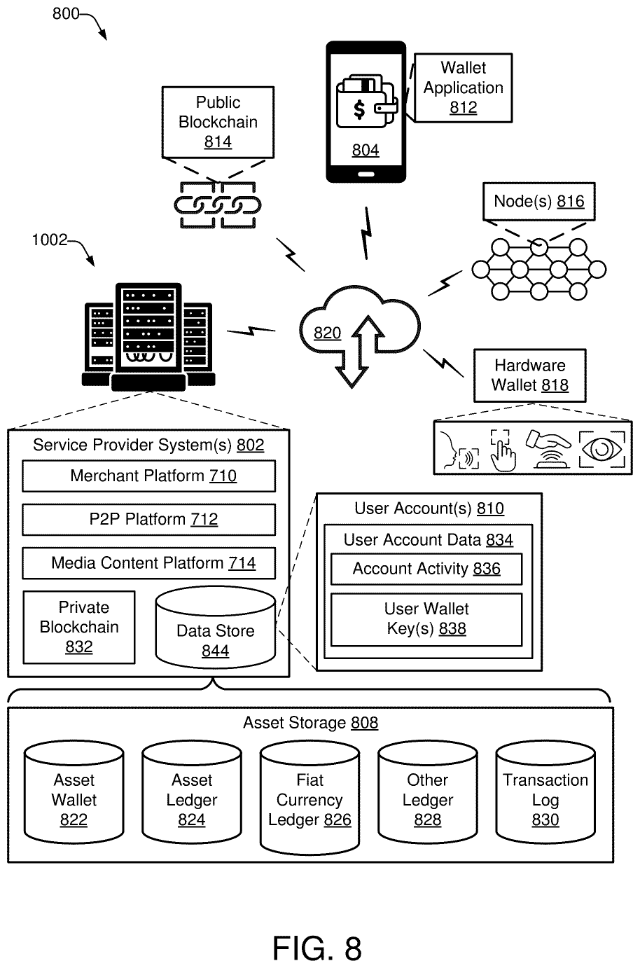

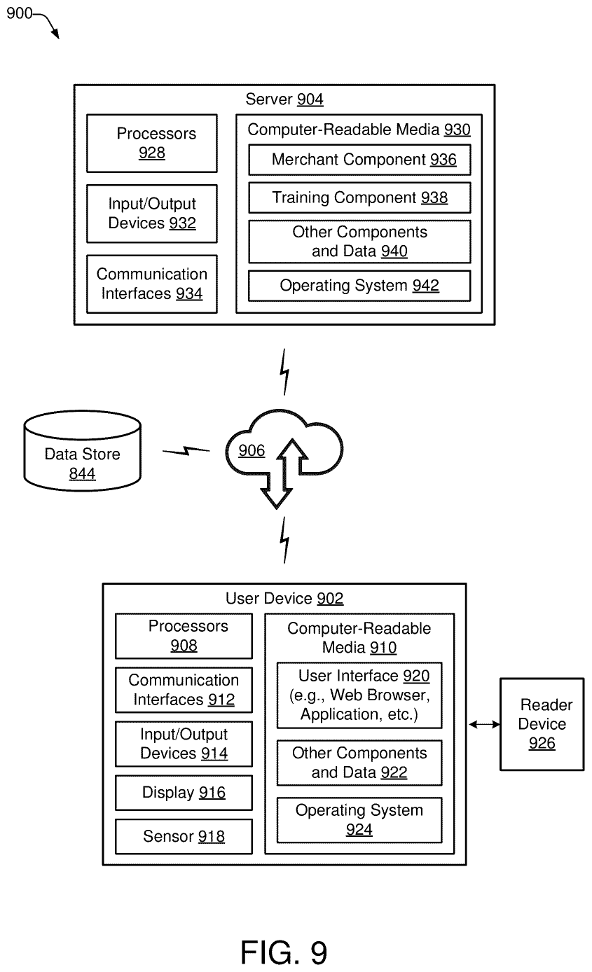

Hereinafter, different example environments that may be suitable for one or more implementations described herein, are presented with reference to FIG. 7, FIG. 8, and FIG. 9.

FIG. 7 illustrates an example environment 700. The environment 700 includes server(s) 702 that can communicate over a network 704 with end user devices 706 and/or server(s) 708 associated with third-party service provider(s). In various examples, the end user devices 706 may comprise one or more seller devices 706(A), one or more user devices 706(B) and/or 706(C) in a peer network, one or more content consumption devices 706(D), one or more artist user devices 706(E), combinations of these examples, or other categories of user devices. The server(s) 702 can be associated with one or more service providers that can provide one or more services for the benefit of users 716, as described below. For example, the server(s) 702 may enable services of service providers such as in association with a merchant platform 710 (which may further include a buyer platform), a peer-to-peer (P2P) payment platform 712, a media content platform 714, a combination of these platforms, or other platforms associated with other service providers. While services and features are referenced throughout in connection with a particular one of the merchant platform 710, the P2P payment platform 712, or the media content platform 714, it should be understood that any of these platforms may perform the functionality described in relation to any of the other platforms. Actions attributed to the service provider(s) can be performed by the server(s) 702.

In some implementations, the service provider network 104 operates with a P2P platform similar to platform 712.

In some examples, individual ones of the end user devices 706 can be operable by users 716. The users 716 (individually referred to herein as “user 716”) can be referred to as customers, buyers, merchants, sellers, borrowers, employees, employers, payors, payees, couriers, artists, musicians, listeners, fans, supervisors, hosts, audience members, and so on. The users 716 can interact with the end user devices 706 via user interfaces presented via the end user devices 706. In at least one example, a user interface can be presented via a web browser, or the like. Alternatively or additionally, a user interface can be presented via an application, such as a mobile application or desktop application, which can be provided by the merchant platform 710, the P2P payment platform 712, and/or the media content platform 714, or which can be an otherwise dedicated application. In some examples, individual end user devices 706 can have an instance or versioned instance of an application, which can be downloaded from an application store, for example, which can present the user interface(s) described herein.

In at least one example, the users 716 can include merchants that can operate the seller device(s) 706(A) that are configured for use by merchants. For the purpose of this discussion, a “merchant” can be any entity that offers items (e.g., goods or services) for purchase or other means of acquisition (e.g., rent, borrow, barter, etc.). The merchants can offer items for purchase or other means of acquisition via brick-and-mortar stores, mobile stores (e.g., pop-up shops, food trucks, etc.), online stores, event venues, combinations of the foregoing, and so forth. In some examples, at least some of the merchants can be associated with the same entity but can have different merchant locations and/or can have franchise/franchisee relationships.

In additional or alternative examples, the merchants can be different merchants. For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN) s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

The seller device 706(A) can have an instance of a point of sale (“POS”) application 720 stored thereon. The POS application 720 can configure the seller device 706(A) as a POS terminal, which enables the merchant to interact with one or more customers. In at least one example, interactions between the customers and the merchants that involve the exchange of funds (from the customers) for items or services (from the merchants) can be referred to as “transactions.” In at least one example, the POS application 720 can determine transaction data associated with the POS transactions. Transaction data can include payment information, which can be obtained from a reader device 722 associated with the seller device 706(A), user authentication data, purchase amount information, point-of-purchase information (e.g., item(s) purchased, date of purchase, time of purchase, subscription type, etc.), etc. The POS application 720 can send transaction data to the server(s) 702 such that the server(s) 702 can track transactions of the customers, merchants, and/or the users 716 over time. Furthermore, the POS application 720 can present a UI to enable the merchant to interact with the POS application 720 and/or the merchant platform 710 via the POS application 720.

In at least one example, the seller device 706(A) can be a special-purpose computing device configured as a POS terminal (via the execution of the POS application 720). In at least one example, the POS terminal may be connected to a reader device 722, which is capable of accepting a variety of payment instruments, such as credit cards, debit cards, gift cards, short-range communication based payment instruments, and the like, as described below. In at least one example, the reader device 722 can plug in to a port in the seller device 706(A), such as a microphone port, a headphone port, an audio-jack, a data port, or other suitable port. In additional or alternative examples, the reader device 722 can be coupled to the seller device 706(A) via another wired or wireless connection, such as via Bluetooth®, BLE, and so on. In some examples, the reader device 722 can be a software solution executing on the POS terminal, e.g., a mobile phone. In some examples, the reader device 722 can read information from alternative payment instruments including, but not limited to, wristbands and the like.

In some examples, the reader device 722 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards, hardware wallets, fobs, or devices configured for tapping). The POS terminal may provide a rich user interface, communicate with the reader device 722, and communicate with the merchant platform 710, which can provide, among other services, a payment processing service. The server(s) 702 associated with the merchant platform 710 can communicate with server(s) 708, as described below. In this manner, the POS terminal and reader device 722 may collectively process transaction(s) between the merchants and customers. In some examples, multiple POS terminal(s) may be connected to a number of other devices, such as “secondary” terminals, e.g., back-of-the-house systems, printers, line-buster devices, reader devices, speakers, and the like, to allow for information from the secondary terminal to be shared between the primary POS terminal(s) and secondary terminal(s), for example via short-range communication technology. This kind of arrangement may continue operation in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 722 of the POS system 724 are shown as separate devices, in additional or alternative examples, the POS terminal and the reader device 722 can be part of a single device. In some examples, the reader device 722 can have a display integrated therein for presenting information to customers of a merchant. In additional or alternative examples, the POS terminal can have a display integrated therein for presenting information to the customers of the merchant. POS systems, such as the POS system 724, may be mobile, such that POS terminals and reader devices may process transactions in disparate locations across the world. POS systems can be used for processing card-present transactions and card-not-present (CNP) transactions.

A card-present transaction is a transaction where both a customer and the customer's payment instrument are physically present at the time of the transaction. Card-present transactions may be contact or contactless transactions processed by swipes (e.g., by sliding a magnetic strip through a reader device), dips (e.g., by inserting an embedded microchip into a reader device), taps (e.g., by wirelessly, through Bluetooth, NFC or other short range technology hover or tap a payment instrument into a reader device), or any other interaction between a physical payment instrument (e.g., a card), or otherwise present payment instrument, and a reader device 722, whereby the reader device 722 is able to obtain payment data from the payment instrument.

A CNP transaction is a transaction where a card, or other payment instrument, is not physically present at the POS such that payment data is manually keyed in (e.g., by a merchant, customer, etc.), or payment data is required to be recalled from a card-on-file data store, to complete the transaction.

The POS system 724, the server(s) 702, and/or the server(s) 708 may exchange payment information and transaction data to determine whether transactions are authorized. For example, the POS system 724 may provide encrypted payment data, user authentication data, purchase amount information, point-of-purchase information, etc. (collectively, transaction data) to server(s) 702 over the network(s) 704. The server(s) 702 may send the transaction data to the server(s) 708.

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. In at least one example, the service provider can serve as an acquirer and connect directly with the card payment network.

The card payment network (e.g., the server(s) 708 associated therewith) can forward the fund transfer request to an issuing bank (e.g., “issuer”). The issuer is a bank or financial institution that offers a financial account (e.g., credit or debit card account) to a user. The issuer (e.g., the server(s) 708 associated therewith) can make a determination as to whether the customer has the capacity to absorb the relevant charge associated with the payment transaction. In at least one example, the merchant platform 710 can serve as an issuer and/or can partner with an issuer. The transaction is either approved or rejected by the issuer and/or the card payment network (e.g., the server(s) 708 associated therewith), and a payment authorization message is communicated from the issuer to the POS device via a path opposite of that described above, or via an alternate path.

The server(s) 708 may send an authorization notification over the network(s) 704 to the server(s) 702, which may send the authorization notification to the POS system 724 over the network(s) 704 to indicate whether the transaction is authorized. The server(s) 702 may also transmit additional information such as transaction identifiers to the POS system 724. In one example, the server(s) 702 may include a merchant application and/or other functional components for communicating with the POS system 724 and/or the server(s) 708 to authorize or decline transactions (e.g., the API 718). In examples, the merchant platform 710 can enable the merchants to receive cash payments, payment card payments, and/or electronic payments from customers for POS transactions and the service provider can process transactions on behalf of the merchants.

Based on the authentication notification that is received by the POS system 724 from server(s) 702, the merchant may indicate to the customer whether the transaction has been approved. In some examples, approval may be indicated at the POS system 724, for example, at a display of the POS system 724. In some cases, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

The merchant platform 710 can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, media content (e.g., music, videos, etc.) management and/or subscription services, and so on. In some examples, the users 706 can access all of the services. In some cases, the users 706 can have gradated access to the services, which can be based on risk tolerance, IDV outputs, subscriptions, and so on. In at least one example, access to such services can be availed to the merchants via the POS application 720. In additional or alternative examples, each service can be associated with its own access point (e.g., application, web browser, etc.).

As the merchant platform 710 processes transactions on behalf of the merchants, the merchant platform 710 can maintain accounts or balances for the merchants in one or more ledgers. For example, the merchant platform 710 can analyze transaction data received for a transaction to determine an amount of funds owed to a merchant for the transaction and deposit funds into an account of the merchant. The account can have a stored balance, which can be managed by the merchant platform 710. The account can be different from a conventional bank account at least because the stored balance is managed by a ledger of the merchant platform 710 and the associated funds are accessible via various withdrawal channels including, but not limited to, scheduled deposit, same-day deposit, instant deposit, and a linked payment instrument.

A scheduled deposit can occur when the merchant platform 710 transfers funds associated with a stored balance of the merchant to a bank account of the merchant that is held at a bank or other financial institution (e.g., associated with the server(s) 708). Scheduled deposits can occur at a prearranged time after a POS transaction is funded, which can be a business day after the POS transaction occurred, or sooner or later. In some examples, the merchant can access funds prior to a scheduled deposit (e.g., same-day deposits and/or real-time deposits). Further, in at least one example, the merchant can have a payment instrument that is linked to the stored balance that enables the merchant to access the funds without first transferring the funds from the account managed by the merchant platform 710 to the bank account of the merchant.

In at least one example, the merchant platform 710 may provide inventory management services. That is, the merchant platform 710 may provide inventory tracking and reporting. Inventory management services may enable the merchant to access and manage a database storing data associated with a quantity of each item that the merchant has available (i.e., an inventory). Furthermore, in at least one example, the merchant platform 710 can provide catalog management services to enable the merchant to maintain a catalog, which can be a database storing data associated with items that the merchant has available for acquisition (i.e., catalog management services). The merchant platform 710 can offer recommendations related to pricing of the items, placement of items on the catalog, and multi-party fulfillment of the inventory, to name a few examples.

In at least one example, the merchant platform 710 can provide business banking services, which allow the merchant to track deposits (from payment processing and/or other sources of funds) into an account of the merchant, payroll payments from the account (e.g., payments to employees of the merchant), payments to other merchants (e.g., business-to-business) directly from the account or from a linked debit card, withdrawals made via scheduled deposit and/or real-time deposit, configure allocations among multiple balances or accounts (e.g., spending, saving, taxes, etc.), etc. Furthermore, the business banking services can enable the merchant to obtain a customized payment instrument (e.g., credit card), check how much money the merchant is earning (e.g., via presentation of available earned balance), understand where the money of the merchant is going (e.g., via deposit reports (which can include a breakdown of fees), spend reports, etc.), access/use earned money (e.g., via scheduled deposit, real-time deposit, linked payment instrument, etc.), have improved control of the money of the merchant (e.g., via management of deposit schedule, deposit speed, linked instruments, etc.), etc. Moreover, the business banking services can enable the merchants to visualize their cash flow to track their financial health, set aside money for upcoming obligations (e.g., savings), organize money around goals, etc.

In at least one example, the merchant platform 710 can provide financing services and products, such as via business loans, consumer loans, fixed term loans, flexible term loans, and the like. In at least one example, the service provider can utilize one or more risk signals to determine whether to extend financing offers and/or terms associated with such financing offers. Such risk signals can be particular to an individual platform or service, as described herein, or can be based on aggregated data associated with multiple of the platforms or services. In at least one example, the merchant platform 710 can provide financing services for offering and/or lending a loan to a borrower that is to be used for, in some instances, financing the borrower's short-term operational needs (e.g., a capital loan). Additionally or alternatively, the merchant platform 710 can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant. The merchant platform 710 can generate the loan based at least in part on determining that the borrower purchased or intends to purchase the item from the merchant. Advances, loans, or other funds provided to a merchant or other user can be repaid via a variety of mechanisms. In some examples, loans can be repaid in installments (e.g., multiple payments over time), at a particular date, from a portion of incoming funds (e.g., payments processed for the merchant, tax refunds, direct deposits, etc.), or the like.

The merchant platform 710 can provide web-development services, which enable users 716 who are unfamiliar with HTML, XML, Javascript, CSS, or other web design tools to create and maintain functional websites. Further, in addition to websites, the web-development services can create and maintain other online omni-channel presences, such as social media posts for example. In some examples, the resulting web page(s) and/or other content items can be used for offering item(s) for sale via an online/e-commerce platform. In at least one example, the merchant platform 710 can recommend and/or generate content items to supplement omni-channel presences of the merchants.

Furthermore, the merchant platform 710 can provide payroll services to enable employers to pay employees for work performed on behalf of employers. In at least one example, the merchant platform 710 can receive data that includes time worked by an employee (e.g., through imported timecards and/or POS interactions), sales made by the employee, gratuities received by the employee, and so forth. Based on such data, the merchant platform 710 can make payroll payments to employee(s) on behalf of an employer via the payroll service. For instance, the merchant platform 710 can facilitate the transfer of a total amount to be paid out for the payroll of an employee from the bank of the employer to the bank of the merchant platform 710 to be used to make payroll payments. In at least one example, when the funds have been received at the bank of the merchant platform 710, the merchant platform 710 can pay the employee, such as by check or direct deposit.

Moreover, in at least one example, the merchant platform 710 can provide employee management services for managing schedules of employees. Further, the merchant platform 710 can provide appointment services for enabling users 716 to set schedules for scheduling appointments and/or users 716 to schedule appointments.

In some examples, the merchant platform 710 can provide restaurant management services to enable users 716 to make and/or manage reservations, to monitor front-of-house and/or back-of-house operations, and so on. In such examples, the seller device(s) 706(A) and/or server(s) 702 can be configured to communicate with one or more other computing devices, which can be located in the front-of-house (e.g., POS device(s)) and/or back-of-house (e.g., kitchen display system(s) (KDS)). In at least one example, the merchant platform 710 can provide order management services and/or fulfillment services to enable restaurants (or other merchant types) to manage open tickets, split tickets, and so on and/or manage fulfillment services.

In some examples, the merchant platform 710 can provide omni-channel fulfillment services. A fulfillment service includes item ordering and delivery services, such as via a courier. In some examples, the courier can be an unmanned aerial vehicle (e.g., a drone), an autonomous vehicle, or any other type of vehicle capable of receiving instructions for traveling between locations. For instance, if a customer places an order with a merchant and the merchant cannot fulfill the order because one or more items are out of stock or otherwise unavailable, the merchant platform 710 can leverage other merchants and/or sales channels that are part of the merchant platform 710 to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the merchant platform 710 can enable conversational commerce via conversational commerce services, which can use one or more machine learning mechanisms to analyze messages exchanged between two or more users 716, voice inputs into a virtual assistant or the like, to determine intents of user(s) 716. In some examples, the merchant platform 710 can utilize determined intents to automate customer service, offer promotions, provide recommendations, or otherwise interact with customers in real-time. In at least one example, the merchant platform 710 can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 716 may be new to the merchant platform 710 such that the user 716 that has not registered (e.g., subscribed to receive access to one or more services offered by the merchant platform 710) with the merchant platform 710. The merchant platform 710 can offer onboarding services for registering a potential user 716 with the merchant platform 710. In some examples, onboarding can involve presenting various questions, prompts, and the like to a potential user 716 to obtain information that can be used to generate a profile for the potential user 716. In at least one example, the merchant platform 710 can provide limited or short-term access to its services prior to, or during, onboarding (e.g., a user of a peer-to-peer payment service can transfer and/or receive funds prior to being fully onboarded, a merchant can process payments prior to being fully onboarded, a user of a music streaming service can listen to music having advertisement breaks prior to being fully onboarded, etc.). In response to full or partial completion of onboarding, any limited or short-term access to services of the merchant platform 710 can be transitioned to more permissive (e.g., less limited) or longer-term access to such services.

The merchant platform 710 can be associated with IDV services, which can be used by the merchant platform 710 for compliance purposes and/or can be offered as a service, for instance to third-party service providers (e.g., associated with the server(s) 708). That is, the merchant platform 710 can offer IDV services to verify the identity of users 716 seeking to use or using their services. Identity verification may involve requesting a customer (or potential customer) to provide information that is used by compliance departments to prove that the information is associated with an identity of a real person or entity (e.g., an artist). In at least one example, the merchant platform 710 can perform services for determining whether identifying information provided by a user 716 accurately identifies the customer (or potential customer).

Techniques described herein can be configured to operate in both real-time/online and offline modes. “Online” modes refer to modes when devices are capable of communicating with the merchant platform 710 while offline mode refers to modes when devices are unable to communicate with the server(s) 708 due to network connectivity issue, for example. In such examples, devices may operate in “offline” mode where at least some payment data is stored (e.g., on the seller device(s) 706(A)) and/or the server(s) 702 until connectivity is restored and the payment data can be transmitted to the server(s) 702 and/or the server(s) 708 for processing.

In at least one example, the merchant platform 710 can be associated with a hub, such as an order hub, an inventory hub, a fulfillment hub and so on, which can enable integration with one or more additional service providers (e.g., associated with the additional server(s) 708). In some examples, such additional service providers can offer additional or alternative services and the service provider can provide an interface or other computer-readable instructions to integrate functionality of the service provider into the one or more additional service providers.

Turning now to the P2P functionality provided by the environment 700, the P2P platform 712 can provide a peer-to-peer payment service that enables peer-to-peer payments between two or more of the users 716. Two or more of the users 716 may be considered “peers” in a peer-to-peer interaction, such as a payment. In at least one example, the P2P platform 712 can communicate with instances of a payment application 726 (or other access point) installed on end user devices 706 configured for operation by the users 716. In an example, an instance of the payment application 726 executing on a first user device 706(B) operated by a payor (e.g., one of the users 716) can send a request to the P2P platform 712 to transfer an asset (e.g., fiat currency, non-fiat currency, digital assets such as non-fungible tokens (NFTs), cryptocurrency, securities, gift cards, and/or related assets) from the payor to a payee (e.g., a different one of the users 716) via a peer-to-peer payment. In some examples, assets associated with an account of the payor are transferred to an account of the payee. In some examples, assets can be held at least temporarily in an account of the P2P platform 712 prior to transferring the assets to the account of the payee.

In some examples, the P2P platform 712 can utilize a ledger system to track transfers of assets between users 716. FIG. 8, below, provides additional details associated with such a ledger system. The ledger system can enable users 716 to own fractional shares of assets that are not conventionally available. For instance, a user can own a fraction of a Bitcoin, an NFT, or a stock. Additional details are described herein.

In at least one example, the P2P platform 712 can facilitate transfers and can send notifications related thereto to instances of the payment application 726 executing on user device(s) of payee(s). As an example, the P2P platform 712 can transfer assets from an account of a first user to an account of a second user and can send a notification to the user device 706(B) of the second user for presentation via a user interface. The notification can indicate that a transfer is in process, a transfer is complete, or the like. In some examples, the P2P platform 712 can send additional or alternative information to the instances of the payment application 726 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the P2P platform 712 funds the request to payee on behalf of the payor, to speed up the transfer process and compensate for lags that may be attributed to the payor's financial network.

In some examples, the P2P platform 712 can trigger the peer-to-peer payment process through identification of a “payment proxy” having a particular syntax. The payment proxy is useable in lieu of payment data. That is, payment data and a payment proxy can be linked to, or otherwise associated with, a user account of a user and either can be used for making payments. In an example, the syntax can include a monetary currency indicator prefixing one or more alphanumeric characters (e.g., $Cash). The currency indicator operates as the tagging mechanism that indicates to the server(s) 702 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol or other symbol could equally be used. In some examples, additional or alternative identifiers can be used to trigger the peer-to-peer payment process. For instance, email, telephone number, social media handles, artist or band names, and/or the like can be used to trigger and/or identify users of a peer-to-peer payment process.

In some examples, the peer-to-peer payment process can be initiated through instances of the payment application 726 executing on the end user devices 706. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can be a uniform resource locator (URL), which can include a payment proxy discussed above. The P2P platform 712 can generate the landing page to enable the recipient to conveniently receive one or more payments from one or more senders.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through streaming of content, comments, posts, messages on electronic bulletin boards, messages on a social networking platform, and/or any other types of messages. In some examples, the content provider can be the service provider as described with reference to FIG. 7 or a third-party service provider associated with the server(s) 708. In examples where the content provider is a third-party service provider, the server(s) 708 can be accessible via one or more APIs 718 or other integrations. In some examples, “forum” may also refer to an application or webpage of an e-commerce or retail organization that offers products and/or services. Such websites can provide an online “form” to complete before or after the products or services are added to a virtual cart. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be internal to the P2P platform 712 (e.g., the P2P platform 712 offers a chat or messaging service that is within the payment application or accessible via the payment application). In some examples, the messaging application can be external to the P2P platform 712. (e.g., the messaging application is hosted by a third-party service provider associated with the server(s) 708, which can be accessible via one or more of the APIs 718 or other integrations). The messaging application can include, for example, a text messaging application for communication between phones (e.g., conventional mobile telephones or smartphones), or a cross-platform instant messaging application for smartphones and phones that use the Internet for communication.

Funds received from payments can be stored in stored balances that are linked to, or otherwise associated with, user accounts. In some examples, the P2P platform 712 can enable users 716 to perform banking transactions via instances of the payment application 726. For example, users can configure direct deposits, recurring deposits, or other deposits (e.g., tax refunds, loans, etc.) for adding assets to their various ledgers/balances. In some examples, users can deposit physical cash via ATMs or other deposit sources, which can include merchants, such as those merchants that utilize the payment processing system described above. In some examples, the P2P platform 712 can enable users to allocate funds between different accounts, sub-accounts, or balances (e.g., spending, saving, different assets, different currencies), etc. Further, users 716 can configure bill pay, recurring payments, and/or the like using assets associated with their accounts. In some examples, the P2P platform 712, with consent of the user, can track individual transactions made using the payment application and can utilize such transaction data to make personalized or customized recommendations, determine creditworthiness, generate tax documentation, and/or the like.

In addition to sending and/or receiving assets via peer-to-peer transactions, the P2P platform 712 enables users to buy and/or sell assets via asset networks such as cryptocurrency networks, securities networks, and/or the like. In some examples, acquisition of such assets can be in whole or fractional shares. The ledger system described below with reference to FIG. 8 can enable such assets to be acquired in fractional shares and/or in real-time or near real-time (by delaying or omitting the need to buy/sell assets via asset networks or exchanges). In some examples, users can “gift” assets to other users, for example, by transferring cryptocurrency, stocks, or the like to one another.

In some examples, the P2P platform 712 can enable users to link payment instruments to their user accounts. As a result, users can use their linked payment instruments to access funds in their accounts or balances. In some examples, the payment instrument can be a credit card, debit card, card linked to multiple accounts or balances via software or hardware, a fob or other object having payment data stored thereon, or the like. In some examples, the payment instrument can be a virtual payment instrument or a physical payment instrument. In some examples, the virtual payment instrument can be issued in real-time or for temporary usage. In some examples, the virtual payment instrument can have the same or different payment data as a corresponding physical payment instrument. Payment instruments can be customizable using a design user interface of the payment application. Such customization can enable users to select colors, stamps, images, text, or the like for surface(s) of their payment instruments. In some examples, users can draw or otherwise interact with the design user interface to personalize surface(s) of their payment instruments.

In some examples, users can associate incentives with their payment instruments. Incentives can be recommended to users based on user preferences (inferred or explicitly identified), geolocation, propensity to redeem, value, and/or the like. In some examples, incentives can be particular to individual merchants, types of merchants, types of transactions, and/or the like. In at least one example, when a user uses their payment instrument at a merchant or type of merchant associated with an incentive, or for a transaction type associated with an incentive, the P2P platform 712 can automatically apply the incentive to the transaction. In some examples, users can gift other users “gift cards” that can be associated with payment instruments. That is, a user can transfer an amount of funds to another user and such funds can be associated with a condition (e.g., merchant, merchant type, transaction type, location, etc.) that, upon satisfaction, enables the amount of funds, or a portion thereof, to be applied to a transaction. In at least one example, when a user uses their payment instrument for a transaction that satisfies the condition, the P2P platform 712 can automatically apply the amount of funds associated with the gift card to the transaction.

In some examples, users can configure their account such that when they use their payment instruments, the P2P platform 712 can deposit an amount of funds into a savings account, investing account, bitcoin account, or the like.

In some examples, users can search for or browse other users, merchants, items, or the like via the payment application. In some examples, search results can be personalized and/or customized for the user (e.g., based on user data collected with consent of the user). In some examples, users can shop or otherwise purchase items from other users, merchants, or the like from within the payment application or via a deep link to a merchant application or website.

The P2P platform 712 can offer primary and secondary accounts, wherein a primary account is a sponsor or other delegate of one or more secondary accounts. Such accounts can be useful for families, wherein a parent or other guardian is a sponsor or delegate to one or more child accounts, or where a child is a sponsor or delegate of an elderly parent's account. In some examples, primary accounts can establish limits on secondary accounts, such as spending limits, or the like. In some examples, the primary account owner is the user legally responsible for the account and their identity may be verifiable for secondary user accounts to perform certain transactions, such as buying/selling cryptocurrency or stocks. In some examples, one or more primary accounts and one or more secondary accounts can form a “group” with shared goals, such as saving, investing, or the like.

The P2P platform 712 can present activity data via an activity user interface of the payment application. In some examples, activity can be presented by merchant, date, time, amount, or the like. In some examples, interactions between entities can be represented in conversational communications such that each interaction or transaction is represented as a message. In some examples, users can interact with individual messages and/or send/request funds from within such a conversational communication. In some examples, such conversational communications can represent conversations of a group of two or more users. Groups can be used to pool funds, obtain group discounts or incentives, or enable multiple users to participate in financial transactions together (e.g., group investing, group savings, etc.).

The P2P platform 712 can offer a variety of financial training or learning opportunities. In some examples, such training or learning can be personalized for individual users, for example, based on user data and/or transaction data of the user that is obtained with consent of the user. In some examples, such user data and/or transaction data can be analyzed to make actionable recommendations with respect to optimizing financial health of users of the P2P platform 712.

In some examples, components of the environment 700 may be integrated to enable payments at the point-of-sale using assets associated with user accounts of the P2P platform 712. As illustrated in the environment 700, the components can communicate with one another via the network 704, where one or more APIs 718 or other functional components can be used to facilitate such communication.

In at least one example, an integration can enable a customer to participate in a transaction via their own computing device (e.g., user device 706(B)) instead of interacting with a merchant device of a merchant, such as the seller device 706(A). In such an example, the POS application 720, associated with a payment processing platform and executable by the seller device 706(A) of the merchant, can present a Quick Response (QR) code, or other code that can be used to identify a transaction (e.g., a transaction code), in association with a transaction between the customer and the merchant. The QR code, or other transaction code, can be provided to the POS application 720 via an API 718 associated with the peer-to-peer payment platform. In an example, the customer can utilize their own computing device, such as the user device 706(B), to capture the QR code, or the other transaction code, and to provide an indication of the captured QR code, or other transaction code, to server(s) 702.

Based at least in part on the integration of the peer-to-peer payment platform and the payment processing platform (e.g., via the API 718), the server(s) 702 of the merchant platform 710 can exchange communications with a payment application 726 associated with the P2P platform 712 and/or the POS application 718 to process payment for the transaction using a peer-to-peer payment where the customer is a first “peer” and the merchant is a second “peer.”

Based at least in part on receiving an indication of which payment method a user (e.g., customer or merchant) intends to use for a transaction, techniques described herein utilize an integration between the P2P platform 712 and merchant platform 710 (which can be a first- or third-party integration) such that a QR code, or other transaction code, specific to the transaction can be used for providing transaction details, location details, customer details, or the like to a computing device of the customer, such as the user device 706(B), to enable a contactless (peer-to-peer) payment for the transaction, and transferring funds from an account of the customer to an account of the merchant.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 706(B), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 720 and the payment application 726, as described herein, can process a payment transaction by routing information input via the merchant application to the payment application for completing a “frictionless” payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. A customer computing device, such as the user device 706(B), can be specially configured as a buyer-facing device having functionality similar to the functionality described above in the brick-and-mortar example.

In some examples, based at least in part on capturing the QR code, or other transaction code, the merchant platform 710 can provide transaction data to the P2P platform 712 for presentation via the payment application 726 on the computing device of the customer, such as the user device 706B (B), to enable the customer to complete the transaction via their own computing device. In some examples, in response to receiving an indication that the QR code, or other transaction code, has been captured or otherwise interacted with via the customer computing device, the P2P platform 712 can determine that the customer authorizes payment of the transaction using funds associated with a stored balance of the customer that is managed and/or maintained by the P2P platform 712. Such authorization can be implicit such that the interaction with the transaction code can imply authorization of the customer. Alternatively or additionally, the P2P platform 712 can request express authorization to process payment for the transaction using the funds associated with the stored balance and the customer can interact with the payment application to expressly authorize the settlement of the transaction. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the P2P platform 712 can transfer funds from the stored balance of the customer to the merchant platform 710. In at least one example, the merchant platform 710 can deposit the funds, or a portion thereof, into a stored balance of the merchant that is managed and/or maintained by the merchant platform 710. In such an example, the merchant platform 710 can be a “peer” to the customer in a peer-to-peer transaction.

In some examples, techniques described herein can enable the customer to interact with the transaction after payment for the transaction has been settled. For example, in at least one example, the merchant platform 710 can cause a total amount of a transaction to be presented via a user interface associated with the payment application 726 such that the customer can provide gratuity, feedback, loyalty information, or the like, via an interaction with the user interface. In another example, the merchant platform 710 can adjust a total amount of a transaction based on events during a shopping experience, such as adding or removing a charge to the total amount based on whether a media content item requested by the customer to be played during a shopping experience was in fact played. In some examples, because the customer has already authorized payment via the P2P platform 712, if the customer inputs a tip and/or an event affecting the total amount of the transaction is triggered, the P2P platform 712 can transfer additional funds, associated with the tip or event, to the merchant platform 710. This pre-authorization (or maintained authorization) of sorts can enable faster, more efficient payment processing when the tip is received and/or the event initiates the trigger. Further, the customer can provide feedback and/or loyalty information via the user interface presented by the payment application, which can be associated with the transaction. Using the pre-authorization techniques described herein results in fewer data transmissions and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 726 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. In some examples, the payment instrument can be associated with the P2P platform 712 as described herein (e.g., a debit card linked to a stored balance of a customer) such that when the payment instrument is caused to interact with a payment reader, the merchant platform 710 can exchange communications with the P2P platform 712 to authorize payment for a transaction and/or provision associated transaction data to a computing device of the customer associated with the transaction.

Turning now to media content functionality provided by the environment 700, the media content platform 714 can provide digital media to a content consumption device 706(D) where playback may occur using “streaming.” In examples, “streaming” media content involves encoding the media content and transmitting the encoded media content over the network 704 to a media player or a media application executing on a device (e.g., via a speaker). The device then decodes and plays the media content while data is being received. In some cases, a buffer queues some of the data of the media content (e.g., audio data, video data, etc.) ahead of the media being played. During moments of network congestion, which leads to lower available bandwidth, less media content data is added to the buffer, which drains down as media content is being dequeued during streaming playback. However, during moments of high network bandwidth, the buffer is replenished, adding media content data to the buffer.

In at least one example, the media content platform 714 can provide a digital media streaming service (e.g., subscription-based, non-subscription-based) that enables a content consumption device 706(D) to stream and/or download digital media content via a listener application 728 installed on the content consumption device 706(D). For instance, the media content platform 714 may comprise a digital audio streaming service (e.g., for music, podcasts, audiobooks, etc.), a digital video streaming service, and/or a streaming service that provides streaming of various different types of digital media content or multimedia. In such cases where digital media content items are downloaded and stored locally on the content consumption devices 706(D), the listener application 728 may verify access rights to the digital media content items at time intervals, for instance intermittently (e.g., when the content consumption device 706(D) has a network connection with the media content platform 714 via the network(s) 704), and/or at regular intervals (e.g., daily, weekly, monthly, etc.). In examples, access rights to the digital media content items may be provided when a subscription to the media content platform 714 is active, while access rights to the digital media content items may be withheld when the subscription to the media content platform 714 is terminated. Enabling storage on the end user devices 706 and subsequent access to digital media content items via the listener application 728 provides the users 716 with the ability to access the digital media content items “offline” such as when a connection to the media content platform 714 via the network(s) 704 is unavailable or unreliable.

In some examples, the media content platform 714 may additionally or alternatively provide an artist management service that enables the users 716 to manage aspects of artist business via an artist application 730 installed on the artist user device 706(E), such as data analytics and management (e.g., listener data, consumer data, etc.), marketing, regulatory obligations, cash flow management, publishing, customer relationship management (CRM), social media, event coordination, industry communications, digital media content ingestion and storage, and so forth. In some cases, the users 716 can have graduated access to the services, which can be based on a user type (e.g., artist, group member, personal manager, business manager, attorney, agent, etc.), risk tolerance, artist verification status, listener and/or viewer analytics (e.g., number of streams in a month), and so on. In some cases, multiple users 716 may have access to a single user account via respective end user devices 706, with the various users having different access privileges to services provided by the artist management service. In various scenarios, an artist can designate functions provided by the artist management service to different members of the team associated with the artist, thus granting the respective team members access to services suited to the skills of the individual team members.

In some cases, the artist application 730 and the listener application 728 may be distinct applications having differing user experiences and verification processes for access, such as illustrated in the environment 700. For instance, the media content platform 714 may request additional verification, such as a link to an artist website, a sample of an artist's work, a verified credential supplied by a third party, etc. to grant access to the artist application 730 in addition to information requested to access the listener application 728. Further, the artist application 730 may provide the artist management services described herein, without the subscription-based digital media streaming services described herein, and vice versa. However, examples are also considered in which functionality provided by the artist application 730 and the listener application 728 partially or fully overlap, and/or where verification processes for access are substantially similar.

In at least some examples, the media content platform 714 enables interaction between the users 716 utilizing the listener application 728 installed on the content consumption devices 706(D), and the users 716 utilizing the artist application 730 installed on the artist user devices 706(E). For example, the media content platform 714 may provide interconnectivity between the subscription-based digital media streaming service and the artist management service. Functionality provided by the media content platform 714 in such instances may include a communication channel between one or more of the users 716 (e.g., a listener, fan, music supervisor, publisher, etc.) utilizing the listener application 728 and another user (e.g., an artist) of the users 716 utilizing the artist application 730. The communication channel may include, for instance, a messaging platform (also referred to as a “messaging application” herein), a live streaming platform, a videoconferencing or teleconferencing platform, and/or a combination of these.

Additionally, in some cases, the media content platform 714 may facilitate a resource transfer between the listener application 728 and the artist application 730. In an example, the media content platform 714 may direct a resource, such as a portion of a subscription fee paid by one of the users 716 designated as a listener, to one or more of the users 716 designated as artists based on a number of instances that the listening user consumed (e.g., streamed, downloaded, etc.) content created by respective ones of the artist users. Alternatively or additionally, the media content platform 714 may direct a resource, such as funds, from an account associated with a listening user to an account associated with an artist user (or vice versa), in accordance with transfers between accounts as described herein. The media content platform 714 may facilitate resource transfers in examples such as merchandise purchases, event ticket purchases, “tipping” an artist, payments for royalties or other fees, and so forth.

In some examples, the media content platform 714 enables interaction between individual ones of the users 716 with one another via the listener application 728 installed on the content consumption device 706(D) and other of the content consumption devices 706(D) via a communication channel as described above. In an example, the listener application 728 may provide functionality via a communication channel for a user to stream an individual digital media item, a playlist, or the like to an audience comprising other ones of the content consumption devices 706(D). Alternatively or additionally, the communication channel may facilitate sharing of individual digital media items, playlists, user and/or artist profiles, and the like between the users 716 via messages, uniform resource locators (URLs), quick response (QR) codes, and so forth.

In some cases, the media content platform 714 enables interaction between individual ones of the users 716 with one another via the artist application 730 installed on the artist user device 706(E) and other of the artist devices 706 via a communication channel as described above. In some instances, the media content platform 714 may provide recommendations for a particular user indicating which of the other users 716 to communicate with. Such a recommendation may be based on a similarity (or dissimilarity) of content created by two or more of the users 716, an overlap (or lack thereof) of audience members of the users 716, a geographic location of the users 716, a coinciding event location of the users 716, and so forth. In some examples, a user may input parameters for a desired connection via the artist application 730, and the media content platform 714 may filter which of the users 716 to surface for recommendations to the user based on the input parameters. Alternatively or additionally, the media content platform 714 may implement one or more machine learning models to filter which of the users 716 to surface for recommendations to the user. The recommendations provided by the media content platform 714 may be data driven and thus increase relevance of communications presented to the users 716 and reduce unsolicited communications that may be received by the users 716.

The media content platform 714 may interact with the server(s) 708 associated with the third-party service providers to, for instance, ingest digital media items, report digital media consumption data, pay royalties, and the like. In some examples, the server(s) 708 may be accessible by the media content platform 714 via one or more APIs 718 or other integrations. In some cases, the third-party service provider may be a digital media content provider (e.g., a record label, a performance rights organization (PRO), an independent artist, etc.). In such cases, the media content platform 714 may receive digital media content items from the server(s) 708, along with metadata associated with the digital media content items. The metadata, in some instances, may indicate individual contributors to a digital media content item such as an artist or artists, a songwriter (e.g., a composer, lyricist, author, etc.), a producer (which may further include a co-producer, a mastering engineer, a mixing engineer, a recording engineer, an arranger, a programmer, etc.), a musician (e.g., instrumentalist, vocalist, etc.), a visual artist, and so forth, with an indication of the role of the individual contributor. Alternatively or additionally, the metadata may indicate information such as release date, track title, track duration, clean or explicit version, jurisdiction information, and the like. The media content platform 714 may use the metadata to associate the digital media content item as being created by a particular user, to provide search results to the users 716, to generate playlists, and so forth. Further, the media content platform 714 may provide payments (e.g., royalties) to the third-party service provider based on a number of streams and/or downloads of individual digital media content items by the users 706 via the listener application 728.

Techniques described herein are directed to services provided via a distributed system of end user devices 706 that are in communication with server(s) 702 of the service provider. That is, techniques described herein are directed to a specific implementation—or, a practical application—of utilizing a distributed system of end user devices 706 that are in communication with server(s) 702 of the merchant platform 710, the P2P platform 712, and/or the media content platform 714 to perform a variety of services, as described above. The unconventional configuration of the distributed system described herein enables the server(s) 702 that are remotely-located from end-users (e.g., users 716) to intelligently offer services based on aggregated data associated with the end-users, such as the users 716 (e.g., data associated with multiple, different merchants and/or multiple, different buyers; data associated with multiple different listeners and/or multiple different artists, etc.), in some examples, in near-real time. Accordingly, techniques described herein are directed to a particular arrangement of elements that offer technical improvements over conventional techniques for performing payment processing services, P2P payment services, media content services, and the like. For small business owners and artists in particular, the business environment is typically fragmented and relies on unrelated tools and programs, making it difficult for an owner or an artist to manually consolidate and view such data. The techniques described herein constantly or periodically monitor disparate and distinct user accounts, e.g., accounts within the control of the merchant platform 710, the P2P platform 712, and/or the media content platform 714, and those outside of the control of these service providers, to track the standing (payables, receivables, payroll, invoices, appointments, capital, balances, collaborations, etc.) of the users 716. The techniques herein provide a consolidated view of a user's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services, P2P payment services, media content services, and/or additional or alternative services described herein. In some implementations, the distributed system is capable of applying the intelligence derived from an existing user base to a new user, thereby making the onboarding experience for the new user personalized and frictionless when compared to traditional onboarding methods. Further, models or algorithms that are used to implement techniques described herein may be retrained over time to improve outcomes for subsequent scenarios based on outcomes of previous scenarios. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 716 and end user devices 706. Furthermore, such features are changed dynamically based on the profiles of the users involved interacting with the GUIs. As such, techniques described herein are directed to improvements to computing systems.

The merchant platform 710, the P2P platform 712, and/or the media content platform 714 are capable of providing additional or alternative services, and the services described above are offered as a sampling of services. In at least one example, the merchant platform 710, the P2P platform 712, and/or the media content platform 714 can exchange data with the server(s) 708 associated with third-party service providers. Such third-party service providers can provide information that enables the merchant platform 710, the P2P platform 712, and/or the media content platform 714 to provide services, such as those described above. In additional or alternative examples, such third-party service providers can access services of the merchant platform 710, the P2P platform 712, and/or the media content platform 714. That is, in some examples, the third-party service providers can be subscribers, or otherwise access, services of the merchant platform 710, the P2P platform 712, and/or the media content platform 714.

FIG. 8 illustrates an example environment 800 including a service provider system 802 which may be associated with the server(s) 702 of FIG. 7. The environment 800 may also include a user device 804, which may correspond to any of the end user devices 706 described in relation to FIG. 7. In examples, the service provider system 802 may include one or a combination of the merchant platform 710, the P2P platform 712, or the media content platform 714, as well as one or more data store(s) 806 that can store assets in an asset storage 808, as well as data in user account(s) 810. In some examples, the environment 800 may also include a public blockchain 814, one or more nodes 816, and/or a hardware wallet 818. The service provider system 802, the user device 804, public blockchain 814, the node(s) 816, and the hardware wallet 818 may be connected and able to communicate via one or more networks 820, which may have the same or similar functionality described in relation to the network 704 of FIG. 7.

In some examples, user account(s) 810 can include merchant account(s), customer account(s), media content subscriber account(s), artist account(s), and so forth. In at least one example, the asset storage 808 can be used to record whether individual assets are registered to a user account 810. For example, the asset storage 808 can include asset wallet(s) 822 for storing records of assets owned by the service provider system 802, such as cryptocurrency, securities, NFTs, or the like, and communicating with one or more asset networks, such as cryptocurrency networks, NFT networks, securities networks, or the like. In some examples, the asset network can be a first-party network or a third-party network, such as a cryptocurrency exchange or the stock market. In examples where the asset network is a third-party network, the server(s) 708 of FIG. 7 can be associated therewith.

The asset wallet 822 can be associated with one or more addresses and can vary addresses used to acquire assets (e.g., from the asset network(s)) so that its holdings are represented under a variety of addresses on the asset network. In examples where the service provider system 802 has holdings of cryptocurrency (e.g., in the asset wallet 822), a user can acquire cryptocurrency directly from the service provider system 802. In some examples, the service provider system 802 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In some scenarios, the buying and selling of cryptocurrency, and therefore the associated updating of the public ledger of an asset network can be separate from a customer-merchant transaction or a peer-to-peer transaction, and therefore not necessarily time-sensitive. This can enable batching transactions to reduce computational resources and/or costs. The service provider system 802 can provide the same or similar functionality for securities or other assets.

The asset storage 808 may contain ledgers that store records of assignments of assets to users 716. Specifically, the asset storage 808 may include asset ledger 824, fiat currency ledger 826, and/or other ledger(s) 828, which can be used to record transfers of assets between users 716 and/or one or more third-parties (e.g., merchant network(s), payment card network(s), ACH network(s), equities network(s), the asset network, securities networks, etc.). In doing so, the asset storage 808 can maintain a running balance of assets managed by the service provider system 802. The ledger(s) of the asset storage 808 can further indicate some of the running balance for individual ledger(s) stored in the asset storage 808 are assigned or registered to one or more user account(s) 810.

In at least one example, the asset storage 808 can include transaction logs 830, which can include, as transaction data, records of past transactions involving the service provider system 802 and/or the user account 810. In some examples, the data store(s) 806 can store a private blockchain 832. A private blockchain 832 can function to record sender addresses, recipient addresses, public keys, values of cryptocurrency transferred, and/or can be used to verify ownership of cryptocurrency tokens to be transferred. In some examples, the service provider system 802 can record transactions involving cryptocurrency until the number of transactions has exceeded a determined limit (e.g., number of transactions, storage space allocation, etc.). Based at least in part on determining that the limit has been reached, the the service provider system 802 can publish the transactions in the private blockchain 832 to the public blockchain 814 (e.g., associated with the asset network), where miners can verify the transactions and record the transactions to blocks on the public blockchain 814. In at least one example, the service provider system 802 can participate as miner(s) at least for transactions to which the respective platform is a party to, to be posted to the public blockchain 814.

In some cases, the data store(s) 806 can store and/or manage multiple user accounts, an example of which is described in relation to the user account 810. In at least one example, the user account 810 can include user account data 834, which can include, but is not limited to, data associated with user identifying information (e.g., name, phone number, address, artist or band name, verfied credentials, etc.), user identifier(s) (e.g., alphanumeric identifiers, etc.), user preferences (e.g., learned or user-specified), purchase history data (e.g., identifying one or more items purchased (and respective item information), subscription tier information, etc.), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 834 can include account activity 836 and user wallet key(s) 838. In some examples, the user wallet key(s) 838 can include a public-private key-pair and a respective address associated with the asset network or other asset networks. In some examples, the user wallet key(s) 838 may include one or more key pairs, which can be unique to the asset network or other asset networks.

In addition to the user account data 834, the user account 810 can include ledger(s) for account(s) managed by the service provider system 802, for the user. For example, the user account 810 may include an asset ledger 824, a fiat currency ledger 826, and/or one or more other ledgers 828. The ledger(s) can indicate that a corresponding user utilizes the service provider system 802 to manage corresponding accounts (e.g., a cryptocurrency account, a securities account, a fiat currency account, an artist account, etc.). It should be noted that in some examples, the ledger(s) can be logical ledger(s) and the data can be represented in a single database. In some examples, individual ones of the ledger(s), or portions thereof, can be maintained by the service provider system 802.

In some examples, the asset ledger 824 can store a balance for each of one or more cryptocurrencies (e.g., Bitcoin, Ethereum, Litecoin, etc.) registered to the user account 810. In at least one example, the asset ledger 824 can further record transactions of cryptocurrency assets associated with the user account 810. For example, the user account 810 can receive cryptocurrency from the asset network using the user wallet key(s) 838. In some examples, the user wallet key(s) 838 may be generated for the user upon request. User wallet key(s) 838 can be requested by the user in order to send, exchange, or otherwise control the balance of cryptocurrency held by the service provider system 802 (e.g., in the asset wallet 822) and registered to the user. In some examples, the user wallet key(s) 838 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider system 802 and the value is credited as a balance in asset ledger 824), by purchasing currency in the form associated with the account using currency in a different form (e.g., buying a value of cryptocurrency from the service provider system 802 using a value of fiat currency reflected in fiat currency ledger 826, and crediting the value of cryptocurrency in asset ledger 824), or by conducting a transaction with another user (customer or merchant) of the service provider system 802 wherein the account receives incoming currency (which can be in the form associated with the account or a different form, in which the incoming currency may be converted to the form associated with the account).

With specific reference to funding a cryptocurrency account, a user may have a balance of cryptocurrency stored in another cryptocurrency wallet. In some examples, the other cryptocurrency wallet can be associated with a third-party unrelated to the service provider system 802 (i.e., an external account). Such a transaction can request that the user to transfer an amount of the cryptocurrency in a message signed by user's private key to an address provided by the service provider system 802. In at least one example, the transaction can be sent to miners to bundle the transaction into a block of transactions and to verify the authenticity of the transactions in the block. Once a miner has verified the block, the block is written to the public blockchain 814 where the service provider system 802 can then verify that the transaction has been confirmed and can credit the user's asset ledger 824 with the transferred amount. When an account is funded by transferring cryptocurrency from a third-party cryptocurrency wallet, an update can be made to the public blockchain 814. In some cases, this update of the public blockchain 814 need not take place at a time-critical moment, such as when a transaction is being processed by a merchant in store or online.

In some examples, a user can purchase cryptocurrency to fund their cryptocurrency account. In some examples, the user can purchase cryptocurrency through services offered by the service provider system 802. As described above, in some examples, the service provider system 802 can acquire cryptocurrency from a third-party source. In examples where the service provider system 802 has its own cryptocurrency assets, cryptocurrency transferred in a transaction (e.g., data with address provided for receipt of transaction and a balance of cryptocurrency transferred in the transaction) can be stored in an asset wallet 822 associated with the service provider system 802. In at least one example, the service provider system 802 can credit the asset ledger 824 of the user. Additionally, while the service provider system 802 recognizes that the user retains the value of the transferred cryptocurrency through crediting the asset ledger 824, an inspection of the blockchain will show the cryptocurrency as having been transferred to the service provider system 802. In some examples, the asset wallet 822 can be associated with many different addresses. In such examples, an inspection of the blockchain may not necessarily associate all cryptocurrency stored in asset wallet 822 as belonging to the same entity. The presence of a private ledger used for real-time transactions and maintained by the service provider system 802, combined with updates to the public ledger at other times, allows for extremely fast transactions using cryptocurrency to be achieved. In some examples, the “private ledger” can refer to the asset ledger 824, which in some examples, can utilize the private blockchain 832, as described herein. The “public ledger” can correspond to the public blockchain 814 associated with the asset network.

In at least one example, an asset ledger 824, fiat currency ledger 826, or the like associated with the user account 810 can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 824. In some examples, a user can receive fiat currency or another currency in the form of payment for a transaction with another user. In at least one example, at least a portion of such funds can be converted into cryptocurrency by the service provider system 802 and used to fund the asset ledger 824 of the user.

In examples, a user can also have an account in U.S. dollars, which can be tracked, for example, via the fiat currency ledger 826. Such an account can be funded by transferring money from a bank account at a third-party bank to an account maintained by the service provider system 802 as is conventionally known. In some examples, a user can receive fiat currency in the form of payment for a transaction with another user. In such examples, at least a portion of such funds can be used to fund the fiat currency ledger 826.

In some examples, a user can have one or more internal payment cards registered with the service provider system 802. Internal payment cards can be linked to one or more of the accounts associated with the user account 810. In some embodiments, options with respect to internal payment cards can be adjusted and managed using an application (e.g., the payment application 726, a wallet application 812, etc.).

In at least one example, the user account 810 can be associated with the asset wallet accessible via a wallet application 812 of the user device 804, or a stored balance for use in payment transactions, peer-to-peer transactions, payroll payments, etc. In at least one example, the asset wallet 822 can store data indicating an address provided for receipt of a cryptocurrency transaction. In at least one example, the balance of the asset wallet 822 can be based at least in part on a balance of the asset ledger 824. In at least one example, funds availed via the asset wallet 822 can be stored in the asset wallet 822. Funds availed via the asset wallet 822 can be tracked via the asset ledger 824. The asset wallet 822, however, can be associated with additional cryptocurrency funds.

In at least one example, when the service provider system 802 includes a private blockchain 832 for recording and validating cryptocurrency transactions, the asset wallet 822 can be used instead of, or in addition to, the asset ledger 824. For example, a merchant can provide the address of the asset wallet 822 for receiving payments. In an example where a customer is paying in cryptocurrency and the customer has their own cryptocurrency wallet account associated with the service provider system 802, the customer can send a message signed by its private key including its wallet address (i.e., of the customer) and identifying the cryptocurrency and value to be transferred to the merchant's asset wallet 822. The service provider system 802 can complete the transaction by reducing the cryptocurrency balance in the customer's cryptocurrency wallet and increasing the cryptocurrency balance in the merchant's asset wallet 822. In addition to recording the transaction in the respective cryptocurrency wallets, the transaction can be recorded in the private blockchain 832 and the transaction can be confirmed. A user can perform a similar transaction with cryptocurrency in a peer-to-peer transaction as described above.

While the asset ledger 824 and/or asset wallet 822 are each described above with reference to cryptocurrency, the asset ledger 824 and/or asset wallet 822 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider system 802 is an aspect of the technology disclosed that enables technical advantages of increased processing speed and improved security.

The description of the environment 800 above generally relates to a centralized service provider system 802 that at least partially facilitates storing and managing assets in the data store 806. However, the environment 800 may also facilitate decentralized storage and management of assets alternatively or in addition to centralized storage and management as described above. For instance, the environment 800 may include a decentralized platform implemented using a plurality of nodes (e.g., web nodes), an example of which is illustrated as node 816. The node 816 is representative of a computer or other device tasked with validating transactions and/or maintaining a copy of a blockchain ledger, such as a ledger associated with the public blockchain 814. The decentralized platform may be implemented via the environment 800 through use of decentralized identifiers and verifiable credentials that are stored and managed by user devices 804. A decentralized identifier is configured as a self-owned identifier that supports decentralized authentication and routing. A self-owned identifier in a blockchain network is a unique identifier that is owned and controlled by an individual entity on the blockchain, as contrasted with an entity controlled by a centralized authority (e.g., the service provider system 802). The decentralized identity referenced by a decentralized identifier gives an entity control over what data can be accessed, stored, modified, and so forth by other entities, such as the service provider system 802.

The node 816, as representative of one of a plurality of decentralized nodes (e.g., decentralized web nodes), supports data storage and relays that allows entities, service provider systems, individuals, organizations and so forth to send, store, and receive encrypted or public messages and data. The node 816 is universally addressable and is “crawlable” using data addressing in relation to the decentralized identifiers. The node 816 is also configured to support decentralized replication of data across the nodes that is consistent across multiple nodes over time through continued data communication between the nodes in the decentralized platform. The node 816 is configurable to support secure encryption through use of a cryptographic key associated with an individual's decentralized identifier and support semantic discovery to discover different forms of published data.

Verifiable credentials are an open standard for digital credentials, and employ a data format for cryptographic presentation and verification of claims. A verifiable credential represents an indication of trust of a piece of information related to an entity. For example, a verifiable credential indicates that the issuer of the verifiable credential trusts the holder of the verifiable credential; the holder trusts a verifier of the verifiable credential; and that the verifier trusts the issuer. Verifiable credentials may be issued by anyone, about anything, and can be presented to and verified by everyone granted access to the verifiable credential. Accordingly, a user of the user device 804 may be an issuer, a holder, and/or a verifier, as can the service provider system 802.

In some examples, the user device 804 may implement a wallet application 812 configured to manage decentralized identifiers and/or verifiable credentials. For instance, the wallet application 812 may provide a user interface for implementation of access controls to various data associated with the decentralized identifier by the service provider system 802, to other user devices, and so forth. Additionally, the wallet application 812 may be configured to provide functionality for resource transfers (e.g., cryptocurrency, fiat currency, etc.) with the service provider system 802, other user devices, and the like, based on techniques described herein.

In some examples, the hardware wallet 818 may store cryptocurrency assets in combination with the wallet application 812 and the service provider system 802. For instance, the hardware wallet 818, the wallet application 812, and the service provider system 802 may each store a respective, different private key, where a transaction with the cryptocurrency assets is signed by at least two of the three private keys. The user interface provided by the wallet application 812 may allow a user to request a transaction. The wallet application 812 may then sign the transaction with the private key of the wallet application 812, have either the hardware wallet 818 or the service provider system 802 use a second of the three private keys to sign the transaction, and then provide the transaction with two signatures to the public blockchain 814 for processing.

FIG. 9 depicts an illustrative block diagram illustrating a system 900 for performing techniques described herein. The system 900 includes a user device 902, that communicates with server computing device(s) (e.g., server(s) 904) via network(s) 906 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 902 is illustrated, in additional or alternate examples, the system 900 can have multiple user devices, as described above with reference to FIG. 7.

In some implementations, user devices 102 are similar to user device 902, and may operate similarly. In at least one example, the user device 902 can be any suitable type of computing device, e.g., portable, semi-portable, semi-stationary, or stationary. Some examples of the user device 902 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, a speaker device, an automobile or other vehicle type, an Internet of Things (IOT) device, etc. That is, the user device 902 can be any computing device capable of sending communications and performing the functions according to the techniques described herein. The user device 902 can include devices, e.g., payment card readers, or components capable of accepting payments, as described below. The user device 902 may be representative of, and provide functionality for, the user devices 706 described in relation to FIG. 7.

In the illustrated example, the user device 902 includes one or more processors 908, one or more computer-readable media 910, one or more communication interface(s) 912, one or more input/output (I/O) devices 914, a display 916, sensor(s) 918, one or more encoders 946, and one or more decoders 948.

In at least one example, each processor 908 can itself comprise one or more processors or processing cores. For example, the processor(s) 908 can be implemented as one or more microprocessors, microcomputers, microcontrollers, digital signal processors, central processing units, state machines, logic circuitries, and/or any devices that manipulate signals based on operational instructions. In some examples, the processor(s) 908 can be one or more hardware processors and/or logic circuits of any suitable type specifically programmed or configured to execute the algorithms and processes described herein. The processor(s) 908 can be configured to fetch and execute computer-readable processor-executable instructions stored in the computer-readable media 910.

Depending on the configuration of the user device 902, the computer-readable media 910 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 910 can include, but is not limited to, RAM, ROM, EEPROM, flash memory, solid-state storage, magnetic disk storage, optical storage, and/or other computer-readable media technology. Further, in some examples, the user device 902 can access external storage, such as RAID storage systems, storage arrays, network attached storage, storage area networks, cloud storage, or any other medium that can be used to store information and that can be accessed by the processor(s) 908 directly or through another computing device or network. Accordingly, the computer-readable media 910 can be computer storage media able to store instructions, components or components that can be executed by the processor(s) 908. Further, when mentioned, non-transitory computer-readable media exclude media such as energy, carrier signals, electromagnetic waves, and signals per se.

The computer-readable media 910 can be used to store and maintain any number of functional components that are executable by the processor(s) 908. In some implementations, these functional components comprise instructions or programs that are executable by the processor(s) 908 and that, when executed, implement operational logic for performing the actions and services attributed above to the user device 902. Functional components stored in the computer-readable media 910 can include a user interface 920 to enable users to interact with the user device 902, and thus the server(s) 904 and/or other networked devices. In some examples, the user interface 920 can be user interface 120a, 120b, 202a, 202b, 202c, and/or 202d. In at least one example, a user can interact with the user interface via touch input, spoken input, gesture, or any other type of input. The word “input” is also used to describe “contextual” input that may not be directly provided by the user via the user interface 920. For example, user's interactions with the user interface 920 are analyzed using, e.g., natural language processing techniques, user movement tracking techniques, eye tracking techniques, etc. to determine context or intent of the user, which may be treated in a manner similar to “direct” user input.

Depending on the type of the user device 902, the computer-readable media 910 can also optionally include other functional components and data, such as other components and data 922, which can include programs, drivers, etc., and the data used or generated by the functional components. In addition, the computer-readable media 910 can also store data, data structures and the like, that are used by the functional components. Further, the user device 902 can include many other logical, programmatic and physical components, of which those described are merely examples that are related to the discussion herein.

In at least one example, the computer-readable media 910 can include additional functional components, such as an operating system 924 for controlling and managing various functions of the user device 902 and for enabling user interactions.

The communication interface(s) 912 can include one or more interfaces and hardware components for enabling communication with various other devices, such as over the network(s) 906 or directly. For example, communication interface(s) 912 can enable communication through one or more network(s) 906, which can include, but are not limited to any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 906 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 902 can further include one or more input/output (I/O) devices 914. The I/O devices 914 can include speakers, a microphone, a camera, and various user controls (e.g., buttons, a joystick, a keyboard, a keypad, etc.), a haptic output device, and so forth. The I/O devices 914 can also include attachments that leverage the accessories (audio-jack, USB-C, Bluetooth, etc.) to connect with the user device 902.

In at least one example, user device 902 can include a display 916. Depending on the type of computing device(s) used as the user device 902, the display 916 can employ any suitable display technology. For example, the display 916 can be a liquid crystal display, a plasma display, a light emitting diode display, an OLED (organic light-emitting diode) display, an electronic paper display, or any other suitable type of display able to present digital content thereon. In at least one example, the display 916 can be an augmented reality display, a virtual reality display, or any other display able to present and/or project digital content. In some examples, the display 916 can have a touch sensor associated with the display 916 to provide a touchscreen display configured to receive touch inputs for enabling interaction with a graphic interface presented on the display 916. Accordingly, implementations herein are not limited to any particular display technology. In some examples, the user device 902 may not include the display 916, and information can be presented by other means, such as aurally, haptically, etc.

In addition, the user device 902 can include sensor(s) 918. The sensor(s) 918 can include a global positioning system (“GPS”) device able to indicate location information. Further, the sensor(s) 918 can include, but are not limited to, an accelerometer, gyroscope, compass, proximity sensor, camera, microphone, and/or a switch.

In some examples, the GPS device can be used to identify a location of a user. In at least one example, the location of the user can be used by the merchant platform 710, the P2P platform 712, and/or the media content platform 714, described above, to provide one or more services. That is, in some examples, the service provider can implement geofencing to provide particular services to users by the merchant platform 710, the P2P platform 712, and/or the media content platform 714.

In examples, the user device 902 includes a codec system, which may comprise an encoder 946 and/or a decoder 948. The encoder 946 is configured to encode a data stream or signal from an analog signal (e.g., an analog audio signal, an analog video signal, etc.) to a digital signal for transmission or storage. The decoder 948 is configured to convert the digital signal back to an analog signal, such as for playback or editing. In some cases, the encoder 946 may be configured to encode the data stream or analog signal in an encrypted format, and the decoder 948 may accordingly be configured to decrypt the digital signal as part of the decoding process (e.g., using a cryptographic key). Additionally, in some examples, the encoder 946 may compress data to reduce transmission bandwidth and/or storage space for the digital signal. One example of a compression codec system is a lossless codec, in which the digital data stream is a compressed format of the original data stream, but retains the information present in the original data stream. Another example of a compression codec system is a lossy codec which reduces the quality of the digital data stream but can increase the compression of the data stream relative to lossless codec systems. The codec system comprising the encoder 946 and/or the decoder 948 may be specialized to accomplish various different objectives, such as to preserve motion, preserve color, minimize latency, maintain fidelity, minimize bit-rate, optimize for different output device types, maintain synchronization of audio and video (e.g., using a metadata synchronization data stream), and so on. Although not explicitly illustrated in the example system 900, the server 904 may include an encoder 946 and/or a decoder 948 as well.

Additionally, the user device 902 can include various other components that are not shown, examples of which include removable storage, a power source, such as a battery and power control unit, a barcode scanner, a printer, a cash drawer, and so forth.

In addition, as described in relation to FIG. 7, the user device 902 can include, be connectable to, or otherwise be coupled to a reader device 926, for reading payment instruments and/or identifiers associated with payment objects. The reader device 926 can include a read head for reading a magnetic strip of a payment card, and further can include encryption technology for encrypting the information read from the magnetic strip. Additionally or alternatively, the reader device 926 can be an EMV payment reader, which in some examples, can be embedded in the user device 902. Moreover, numerous other types of readers can be employed with the user device 902 herein, depending on the type and configuration of the user device 902.

The reader device 926 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data from various types of payment instruments. Accordingly, the reader device 926 may include hardware implementation, such as slots, magnetic tracks, and rails with one or more sensors or electrical contacts to facilitate detection and acceptance of a payment instrument. That is, the reader device 926 may include hardware implementations to enable the reader device 926 to interact with a payment instrument via a swipe, a dip, or a tap to obtain payment data associated with a customer. Additionally or optionally, the reader device 926 may also include a biometric sensor to receive and process biometric characteristics and process them as payment instruments, given that such biometric characteristics are registered with the payment service and connected to a financial account with a bank server. The reader device 926 may include processing unit(s), computer-readable media, a reader chip, a transaction chip, a timer, a clock, a network interface, a power supply, and so on. That is, the reader device 926 may include any of the computing components described herein with reference to the user device 902 to implement the functionality provided by the reader device 926.

In examples, the reader device 926 includes a reader chip, which may perform functionality to control the power supply, among other functionality of the reader device 926. The power supply may include one or more power supplies such as a physical connection to AC power or a battery. Power supply may include power conversion circuitry for converting AC power and generating a plurality of DC voltages for use by components of reader device 926. When power supply includes a battery, the battery may be charged via a physical power connection, via inductive charging, or via any other suitable method.

The reader device 926 may also include a transaction chip that may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. The transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 902, which can be a POS terminal, and the reader device 926 are shown as separate devices, in additional or alternative examples, the user device 902 and the reader device 926 can be part of a single device, which may be a battery-operated device. In some examples, the reader device 926 can have a display integrated therewith, which can be in addition to (or as an alternative of) the display 916 associated with the user device 902.

The server(s) 904 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 904 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 904 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 904 can include one or more processors 928, one or more computer-readable media 930, one or more I/O devices 932, and one or more communication interfaces 934. Each processor 928 can be a single processing unit or a number of processing units, and can include single or multiple computing units or multiple processing cores. The processor(s) 928 can be implemented as one or more microprocessors, microcomputers, microcontrollers, digital signal processors, central processing units, state machines, logic circuitries, and/or any devices that manipulate signals based on operational instructions. For example, the processor(s) 928 can be one or more hardware processors and/or logic circuits of any suitable type specifically programmed or configured to execute the algorithms and processes described herein. The processor(s) 928 can be configured to fetch and execute computer-readable instructions stored in the computer-readable media 930, which can program the processor(s) 928 to perform the functions described herein.

The computer-readable media 930 can include volatile and nonvolatile memory and/or removable and non-removable media implemented in any type of technology for storage of information, such as computer-readable instructions, data structures, program components, or other data. Such computer-readable media 930 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 904, the computer-readable media 930 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 930 can be used to store any number of functional components that are executable by the processor(s) 928. In many implementations, these functional components comprise instructions or programs that are executable by the processors 928 and that, when executed, specifically configure the one or more processors 928 to perform the actions attributed above to the merchant platform 710, the P2P platform 712, and/or the media content platform 714. Functional components stored in the computer-readable media 930 can optionally include a merchant component 936, a training component 938, and one or more other components and data 940. The computer-readable media 930 can additionally include an operating system 942 for controlling and managing various functions of the server(s) 904.

The merchant component 936 can be configured to receive transaction data from POS systems, such as the POS system 624 described above with reference to FIG. 6. The merchant component 936 can transmit requests (e.g., authorization, capture, settlement, etc.) to payment service server computing device(s) to facilitate POS transactions between merchants and customers. The merchant component 936 can communicate the successes or failures of the POS transactions to the POS systems.

The training component 938 can be configured to train models using machine-learning mechanisms, as well as retrain the models to improve outputs provided by the models based on feedback received over time. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 902 and/or the server(s) 904 for use at a time after the data models have been trained (e.g., at runtime).

The one or more other components and data 940 can include aggregation component 132, tokenization component 140, fraud management service 145, language model 144, and/or classification model 148, the functionality of which is described, at least partially, above. Further, the one or more other components and data 940 can include programs, drivers, etc., and the data used or generated by the functional components. Further, the server(s) 904 can include many other logical, programmatic and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The communication interface(s) 934 can include one or more interfaces and hardware components for enabling communication with various other devices, such as over the network(s) 906 or directly. For example, communication interface(s) 934 can enable communication through one or more network(s) 906, which can include, but are not limited to any type of network known in the art, as described herein.

The server(s) 904 can further be equipped with various I/O devices 932. Such I/O devices 932 can include a display, various user interface controls (e.g., buttons, joystick, keyboard, mouse, touch screen, biometric or sensory input devices, etc.), audio speakers, connection ports and so forth.

In at least one example, the system 900 can include a datastore 944 that can be configured to store data that is accessible, manageable, and updatable. In some examples, the datastore 944 can be integrated with the user device 902 and/or the server(s) 904. In other examples, as shown in FIG. 9, the datastore 944 can be located remotely from the server(s) 904 and can be accessible to the server(s) 904. The datastore 944 can comprise multiple databases and/or servers connected locally and/or remotely via the network(s) 906. In at least one example, the datastore 944 can store user profiles, which can include merchant profiles, customer profiles, artist profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, media content consumption data (e.g., number of streams of media content and by which artists, direct artist payouts, playlists generated or “favorited,” durations of listening and/or watching individual media content items, actions performed while consuming media content (e.g., skips, repeats, volume changes, etc.), locations at which media content is consumed, devices used to consume media content, activities during which media content is consumed, etc.), etc.

Artist profiles can store data including, but not limited to, artist information (e.g., artist's performance or stage name, band name, artist's legal name, record label, phone number, address, social media handles, website address, banking information, etc.), artist preferences (e.g., learned or artist-specified), media content (and/or associated data) at least partially attributed to the artist (e.g., songs, videos, artists in a same genre or having shared listeners, etc.), event data (e.g., tour dates, appearance dates, appointments, etc.), financial data (e.g., advance data, recoupment data, royalty data, payouts data, etc.), payroll data (e.g., employees, contractors, venues, payroll frequency, etc.), listening data (e.g., number of streams on media content platform(s), listening trends, etc.), fan data (number of followers on media content platform(s), number of followers on social media platform(s), etc.), reservations data (e.g., venue reservations, studio recording reservations, previous reservations, upcoming (scheduled) reservations, reservation duration, interactions associated with such reservations, etc.), inventory data (e.g., merchandise inventory), customer service data, and so forth.

Furthermore, in at least one example, the datastore 944 can store inventory database(s) and/or catalog database(s). As described above, an inventory can store data associated with a quantity of each item that a merchant has available to the merchant. Furthermore, a catalog can store data associated with items that a merchant has available for acquisition. The datastore 944 can store additional or alternative types of data as described herein.

### Example Clauses

Clause 1: A computer-implemented method, comprising: monitoring user inputs associated with personalized interactions between a first user of an application and other users of the application; building a historical model for the first user based on the monitored user inputs to classify the personalized interactions; in association with a pending personalized interaction and in real-time: associating a new user input with the historical model to generate an aggregated feature set; analyzing the aggregated feature set to identify a pattern of personalized interactions that satisfy a condition; and determining that the pending personalized interaction exceeds a threshold similarity value to the identified pattern; and interrupting the pending personalized interaction based on determining that the pending personalized interaction exceeds the threshold similarity value.

Clause 2: A computer-implemented method according to any preceding clause, wherein the aggregated feature set is a set of tokenized features, and the method further comprises generating embeddings based on the set of tokenized features.

Clause 3: A computer-implemented method according to any preceding clause, wherein analyzing the aggregated feature set analyzing the embeddings using a classification model.

Clause 4: A computer-implemented method according to any preceding clause, wherein aggregating the user inputs comprises aggregating data associated with previous interactions between the first user and the other users within a time window that includes the pending interaction, wherein one or more previous interactions associated with a respective timestamp within the time window are included in the aggregating and previous interactions associated with timestamps outside the time window are excluded in the aggregating.

Clause 5: A computer-implemented method according to any preceding clause, wherein aggregating the user inputs comprises aggregating data associated with a configurable number of previous interactions between the first user and the other users.

Clause 6: A computer-implemented method according to any preceding clause, wherein the user inputs include one or more personalized descriptions of an interaction, the personalized descriptions including any one of: text, image, and emoji.

Clause 7: A computer-implemented method according to any preceding clause, wherein the personalized interactions include any one of: personalized payments, peer-to-peer payments, and payment application transactions.

Clause 8: A computer-implemented method according to any preceding clause, wherein the identified pattern of personalized interactions is a pattern of fraudulent transactions or illegal transactions.

Clause 9: A computer-implemented method according to any preceding clause, wherein interrupting the pending personalized interaction comprises at least one of: flagging the pending personalized interaction for further review, denying the pending personalized interaction, cancelling the pending personalized interaction, and pausing the pending personalized interaction.

Clause 10: A computer-implemented method according to any preceding clause, further comprising translating visual data or emoji data in the user inputs into translated text, and tokenizing the translated text into the aggregated feature set.

Clause 11: A computer-implemented method comprising: receiving and storing user inputs associated with interactions between users of an application; building historical models based on the user inputs to classify the interactions, wherein building a historical model for a particular user comprises aggregating particular user inputs associated with a set of previous interactions between a particular user and other users; in association with a pending interaction for the particular user and during the pending interaction: associating a current user input with the historical model for the particular user; and based on analyzing the historical model for the particular user, determining that the pending interaction satisfies a condition; and interrupting the pending interaction based on determining that the pending interaction satisfies the condition.

Clause 12: A computer-implemented method according to any preceding clause, wherein associating the current user input with the historical model comprises generating an aggregated feature set, and the method further comprises generating embeddings based on the aggregated feature set.

Clause 13: A computer-implemented method according to any preceding clause, wherein analyzing the historical model comprises analyzing the embeddings using a classification model.

Clause 14: A computer-implemented method according to any preceding clause, wherein aggregating the user inputs comprises aggregating data associated with previous interactions between the particular user and the other users within a time window that includes the pending interaction, wherein one or more previous interactions associated with a respective timestamp within the time window are included in the aggregating and previous interactions associated with timestamps outside the time window are excluded in the aggregating.

Clause 15: A computer-implemented method according to any preceding clause, wherein aggregating the user inputs comprises aggregating data associated with a configurable number of previous interactions between the users.

Clause 16: A computer-implemented method according to any preceding clause, wherein the application is: a personalized payment application or peer-to-peer payment application.

Clause 17. A system, comprising: one or more processors; and one or more memories, coupled to the one or more processors and having computer-readable instructions stored thereon, which when executed by one or more processors of the system, cause the system to: monitor user inputs associated with personalized interactions between a first user of an application and other users of the application; build a historical model for the first user based on the monitored user inputs to classify the personalized interactions; in association with a pending personalized interaction and in real-time: associate a new user input with the historical model to generate an aggregated feature set; and analyze the aggregated feature set to identify a pattern of personalized interactions that satisfy a condition; and interrupt the pending personalized interaction based on determining that the pattern of personalized interactions satisfy the condition.

Clause 18: A system according to any preceding clause, wherein the aggregated feature set is a set of tokenized features, and the system is further configured to generate embeddings based on the set of tokenized features, and wherein analyzing the historical model comprises analyzing the embeddings using a classification model deployed at the system.

Clause 19: A system according to any preceding clause, wherein the operations further cause the system to: determine that the pending personalized interaction exceeds a threshold similarity value to the identified pattern; and interrupt the pending personalized interaction based on determining that the pending personalized interaction exceeds the threshold similarity value.

Clause 20: A system according to any preceding clause, wherein the user inputs include one or more personalized descriptions of an interaction, the personalized descriptions including any one of: text, image, and emoji.

### CONCLUSION

Although the subject matter has been described in language specific to structural features and/or methodological acts, it is to be understood that the subject matter defined in the appended claims is not necessarily limited to the specific features or acts described. Rather, the specific features and steps are disclosed as example forms of implementing the claims.

All of the methods and processes described above may be embodied in, and fully or partially automated via, software code modules executed by one or more general purpose computers or processors. The code modules may be stored in any type of computer-readable storage medium or other computer storage device. Some or all of the methods may additionally or alternatively be embodied in specialized computer hardware.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described in the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A computer-implemented method, comprising:
monitoring user inputs associated with personalized interactions between a first user of an application and other users of the application;
building a historical model for the first user based on the monitored user inputs to classify the personalized interactions;
in association with a pending personalized interaction and in real-time:
associating a new user input with the historical model to generate an aggregated feature set;
analyzing the aggregated feature set to identify a pattern of personalized interactions that satisfy a condition; and
determining that the pending personalized interaction exceeds a threshold similarity value to the identified pattern; and
interrupting the pending personalized interaction based on determining that the pending personalized interaction exceeds the threshold similarity value.

2. The computer-implemented method of claim 1, wherein the aggregated feature set is a set of tokenized features, and the method further comprises generating embeddings based on the set of tokenized features.

3. The computer-implemented method of claim 2, wherein analyzing the aggregated feature set analyzing the embeddings using a classification model.

4. The computer-implemented method of claim 1, wherein aggregating the user inputs comprises aggregating data associated with previous interactions between the first user and the other users within a time window that includes the pending interaction, wherein one or more previous interactions associated with a respective timestamp within the time window are included in the aggregating and previous interactions associated with timestamps outside the time window are excluded in the aggregating.

5. The computer-implemented method of claim 1, wherein aggregating the user inputs comprises aggregating data associated with a configurable number of previous interactions between the first user and the other users.

6. The computer-implemented method of claim 1, wherein the user inputs include one or more personalized descriptions of an interaction, the personalized descriptions including any one of: text, image, and emoji.

7. The computer-implemented method of claim 1, wherein the personalized interactions include any one of: personalized payments, peer-to-peer payments, and payment application transactions.

8. The computer-implemented method of claim 1, wherein the identified pattern of personalized interactions is a pattern of fraudulent transactions or illegal transactions.

9. The computer-implemented method of claim 1, wherein interrupting the pending personalized interaction comprises at least one of: flagging the pending personalized interaction for further review, denying the pending personalized interaction, cancelling the pending personalized interaction, and pausing the pending personalized interaction.

10. The computer-implemented method of claim 1, further comprising translating visual data or emoji data in the user inputs into translated text, and tokenizing the translated text into the aggregated feature set.

11. A computer-implemented method comprising:
receiving and storing user inputs associated with interactions between users of an application;
building historical models based on the user inputs to classify the interactions, wherein building a historical model for a particular user comprises aggregating particular user inputs associated with a set of previous interactions between a particular user and other users;
in association with a pending interaction for the particular user and during the pending interaction:
associating a current user input with the historical model for the particular user; and
based on analyzing the historical model for the particular user, determining that the pending interaction satisfies a condition; and
interrupting the pending interaction based on determining that the pending interaction satisfies the condition.

12. The computer-implemented method of claim 11, wherein associating the current user input with the historical model comprises generating an aggregated feature set, and the method further comprises generating embeddings based on the aggregated feature set.

13. The computer-implemented method of claim 12, wherein analyzing the historical model comprises analyzing the embeddings using a classification model.

14. The computer-implemented method of claim 11, wherein aggregating the user inputs comprises aggregating data associated with previous interactions between the particular user and the other users within a time window that includes the pending interaction, wherein one or more previous interactions associated with a respective timestamp within the time window are included in the aggregating and previous interactions associated with timestamps outside the time window are excluded in the aggregating.

15. The computer-implemented method of claim 11, wherein aggregating the user inputs comprises aggregating data associated with a configurable number of previous interactions between the users.

16. The computer-implemented method of claim 1, wherein the application is: a personalized payment application or peer-to-peer payment application.

17. A system, comprising:
one or more processors; and
one or more memories, coupled to the one or more processors and having computer-readable instructions stored thereon, which when executed by one or more processors of the system, cause the system to:
monitor user inputs associated with personalized interactions between a first user of an application and other users of the application;
build a historical model for the first user based on the monitored user inputs to classify the personalized interactions;
in association with a pending personalized interaction and in real-time:
associate a new user input with the historical model to generate an aggregated feature set; and
analyze the aggregated feature set to identify a pattern of personalized interactions that satisfy a condition; and
interrupt the pending personalized interaction based on determining that the pattern of personalized interactions satisfy the condition.

18. The system of claim 17, wherein the aggregated feature set is a set of tokenized features, and the system is further configured to generate embeddings based on the set of tokenized features, and wherein analyzing the historical model comprises analyzing the embeddings using a classification model deployed at the system.

19. The system of claim 17, wherein the operations further cause the system to:
determine that the pending personalized interaction exceeds a threshold similarity value to the identified pattern; and
interrupt the pending personalized interaction based on determining that the pending personalized interaction exceeds the threshold similarity value.

20. The system of claim 17, wherein the user inputs include one or more personalized descriptions of an interaction, the personalized descriptions including any one of: text, image, and emoji.
